(19) United States
(12) Patent Application Publication
(10) Pub. No.: US 2007/0250820 A1
(43) Pub. Date: Oct. 25, 2007

(54) Instruction level execution analysis for debugging software

(75) Inventors: Andrew James Edwards, Bellevue, WA (US); J. Jordan Tigani, Seattle, WA (US); Zhenghao Wang, Redmond, WA (US)

Correspondence Address: KLARQUIST SPARKMAN LLP, 121 S.W. SALMON STREET, SUITE 1600, PORTLAND, OR, 97204, US

(73) Assignee: Microsoft Corporation, Redmond, WA (US)

(21) Appl. No.: 11/409,455

(22) Filed: Apr. 20, 2006

(51) Int. Cl. G06F 9/44

(52) U.S. Cl. 717/131

(57) ABSTRACT

An execution of a software program can be analyzed to detect various conditions, such as software defects relating to pointers and the like. Analysis can include modeling software constructs such as heaps, calls, memory, threads, and the like. Additional information, such as call stacks, can be provided to assist in debugging. A graphical depiction of pointer history can be presented and used to navigate throughout the execution history of a program.

### BACKGROUND

Debugging computer software can be a particularly challenging endeavor. Software defects (“bugs”) are notoriously difficult to locate and analyze. Various approaches have been used to simplify debugging. For example, static program analysis can analyze a program to detect potential bugs. A programmer can then modify the program as appropriate.

However, static analysis techniques are limited in their ability and usefulness in locating bugs. Accordingly, some defects are still located by resorting to software testing. To achieve software testing, various execution scenarios are tested by a tester, who watches for observable defects, such as program crashes or other errors. The tester can then report the bug, and a software developer can attempt to find the bug and its cause via a debugger. Ultimately, the program can then be revised to avoid the bug.

While testing and debugging with a debugger are useful, there are some defects that may not appear even in extensive testing. And, even after such a defect is found, it may be very time consuming to find the cause of the defect with a debugger. For example, due to complex interaction between threads, it may be difficult to recreate the bug. Certain bugs are particularly evasive because a program may run correctly many times without encountering any manifestation of the bug. For example, memory leaks may not cause the program to crash at first, but the program eventually runs out of memory. Thus, the bug may not manifest itself until after the program has been running for an extended period of time.

Accordingly, there remains room for improvement in analyzing programs for potential bugs and finding the cause of such bugs. For example, it would be useful to have a reliable way to find evasive bugs, such as memory leaks, dangling pointers, use of uninitialized values, and the like.

### SUMMARY

An execution of a software program can be analyzed to detect program conditions, such as software defects. For example, detection of memory leaks, dangling pointers, uninitialized values, and the like can be achieved. Analysis can include modeling software constructs such as heaps, calls, memory, threads, and the like. Additional information, such as call stacks, can be provided to assist in debugging. A depiction of a pointer history can be presented and used to navigate throughout the execution history of a program.

Because an actual execution of the software program can be analyzed, it is possible to find bugs even if they do not manifest themselves to a user of the program. For example, memory leaks, dangling pointers, or uses of uninitialized value can be detected. Thus, bugs that typically evade testing can be found.

The foregoing and other features and advantages will become more apparent from the following detailed description of disclosed embodiments, which proceeds with reference to the accompanying drawings.

### BRIEF DESCRIPTION OF THE FIGURES

FIG. 1 is a block diagram of an exemplary execution analysis system.

FIG. 2 is a flowchart of an exemplary method of detecting a program condition that can be implemented in a system such as that shown in FIG. 1.

FIG. 3 is a block diagram of a system generating an indication of a program defect based on a stream of executing instructions.

FIG. 4 is a flowchart of an exemplary method generating an indication of a software defect via models of software constructs.

FIG. 5 is a block diagram showing an exemplary tracker configured to model a software construct.

FIG. 6 is a flowchart of an exemplary method for modeling a software construct.

FIG. 7 is a block diagram of an exemplary checker for detecting a software defect via information provided by trackers.

FIG. 8 is a flowchart of an exemplary method of identifying a software defect in a program via rules.

FIG. 9 is a block diagram of an exemplary system employing trackers and a checker to identify a software defect relating to pointers in a program.

FIG. 10 is a flowchart of an exemplary method of identifying a software defect relating to pointers in a program.

FIG. 11 is a block diagram of an exemplary data flow tracker.

FIG. 12 is a flowchart of an exemplary method of tracking pointers and can be implemented, for example, by a tracker such as that shown in FIG. 11.

FIGS. 13A-D are block diagrams showing a data flow tracker tracking pointers to an object.

FIG. 14 is a block diagram of an exemplary instruction tracker.

FIG. 15 is a block diagram of an exemplary call tracker.

FIG. 16 is a block diagram of an exemplary heap tracker.

FIG. 17 is a block diagram of an exemplary memory tracker.

FIG. 18 is a block diagram of an exemplary thread tracker.

FIG. 19 is a block diagram of an exemplary call stack tracker.

FIG. 20 is a flowchart of an exemplary method for storing call stacks via a hash.

FIG. 21 is a block diagram of an exemplary arrangement for storing call stacks via a hash.

FIG. 22 is a block diagram of an exemplary system employing trackers and a checker to detect a memory leak.

FIG. 23 is a flowchart of an exemplary method of detecting a memory leak.

FIGS. 24A-B are block diagrams showing examples of detecting whether a memory leak has occurred during execution of a program.

FIG. 25 is a flowchart of an exemplary method for detecting whether a memory leak has occurred during execution of a program.

FIG. 26 is a block diagram of an exemplary system employing trackers and a checker to detect use of an uninitialized value during execution of a program.

FIG. 27 is a flowchart of an exemplary method for detecting whether an uninitialized value has been used during execution of a program.

FIG. 28 is a block diagram of an exemplary system employing trackers and a checker to detect use of a dangling pointer during execution of a program.

FIG. 29 is a flowchart of an exemplary method for detecting whether a dangling pointer has been used during execution of a program.

FIG. 30A is a block diagram of an exemplary system call tracker.

FIG. 30B is a block diagram of an exemplary annotation language checker.

FIG. 31 is a block diagram of an exemplary custom checker for detecting a software defect.

FIG. 32 is a block diagram of an exemplary user interface for presenting a history of pointers to an object.

FIG. 33 is a screen shot of an exemplary user interface for presenting a history of pointers to an object.

FIG. 34 is a screenshot of an exemplary user interface for presenting a graphical history of pointers to an object.

FIG. 35 is a flowchart of an exemplary method of presenting a graphical depiction of a history of pointers to an object.

FIG. 36 is a flowchart of an exemplary method of navigating in a debugger via a graphical depiction of a history of pointers to an object.

FIG. 37 is a block diagram of an exemplary data structure for storing an instruction.

FIG. 38 is a flowchart of an exemplary method for performing an analysis of an execution of a program via two passes.

FIG. 39 is a block diagram of an exemplary suitable computing environment for implementing described implementations.

FIG. 40 is a block diagram of an exemplary system employing a combination of the technologies described herein.

FIG. 41 is a flowchart of an exemplary method employing a combination of the technologies described herein and can be implemented in a system such as that shown in FIG. 40.

FIG. 42 is a block diagram of a system generating information about machine state via a compressed program recording.

FIG. 43 is a flowchart of an exemplary method generating information about machine state via playback.

FIG. 44 is a block diagram showing an exemplary compression technique for use in program recordings.

FIG. 45 is a flowchart of an exemplary method for compressing a program recording via predictability.

FIG. 46 is a block diagram of an exemplary system for determining memory state via compressed recorded memory state information and a representation of executable instructions.

FIG. 47 is a flowchart showing an exemplary method of using a predictor and compressed recorded memory state information to determine memory state.

FIG. 48 is a block diagram of an exemplary system employing a cache to determine predictability of memory read operations.

FIG. 49 is a flowchart showing an exemplary method of employing a cache to determine predictability of memory read operations.

FIG. 50 is a flowchart of an exemplary method for managing a cache to reflect predictability.

FIG. 51 a block diagram of an exemplary system employing a cache to take advantage of predictability of memory read operations during playback.

FIG. 52 is a flowchart showing an exemplary method of employing a cache to determine the value of memory read operations via predictability as indicated in a compressed program recording.

FIG. 53 is a flowchart of an exemplary method for managing a cache to take advantage of predictability.

FIG. 54 is a flowchart of an exemplary method of determining a value for a memory address at a particular time.

FIG. 55 is a drawing showing a request for a value of a memory location deep within playback data.

FIG. 56 is a block diagram showing exemplary use of key frames within a compressed program recording.

FIG. 57 is a flowchart of an exemplary method of generating key frames.

FIG. 58 is a block diagram of an exemplary key frame.

FIG. 59 is a flowchart showing an exemplary method of employing a key frame.

FIG. 60 shows a scenario involving a request for a memory value deep within a program recording with key frames.

FIG. 61 is a drawing of an exemplary summarization index associating key frames with memory addresses.

FIG. 62 is a flowchart of an exemplary method of generating a summarization index.

FIG. 63 is a flowchart showing an exemplary method of processing a request for finding key frames associated with a memory address.

FIG. 64 shows a scenario involving a change to a memory address at a time remote from the time for which the value of the memory address was requested.

FIG. 65 is a block diagram showing the use of snapshots to store values for a set of memory locations.

FIG. 66 is a flowchart showing an exemplary method of processing a request for the value of a memory address using one or more snapshots.

FIG. 67 is a flowchart of a method of processing a request for the value of a memory address using one or more snapshots and a summarization index.

FIG. 68 is a block diagram of a compressed program recording supporting multiple processors.

FIG. 69 is a flowchart of an exemplary method of generating a compressed program recording supporting multiple processors.

FIG. 70 is a block diagram of a compressed program recording supporting multiple processors with sequence indications for synchronization.

FIG. 71 is a flowchart of an exemplary method for generating sequence numbers for a compressed program recording supporting multiple processors.

### DETAILED DESCRIPTION

### Example 1

### Exemplary System Employing a Combination of the Technologies

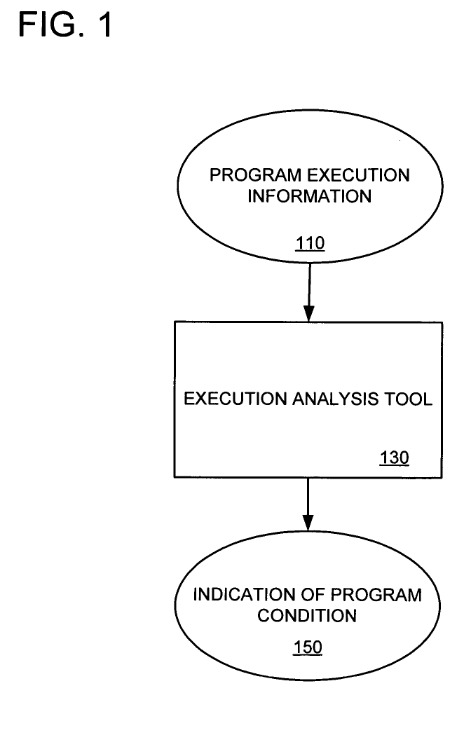

FIG. 1 is a block diagram of an exemplary execution analysis system 100 that can be configured to include any combination of the technologies described herein. Such a system 100 can be provided separately or as part of a software development environment (e.g., with a debugger).

In the example, program execution information 110 is input into an execution analysis tool 130, which generates an indication of a program condition 150 based at least on the program execution information 110.

### Example 2

### Exemplary System Employing a Combination of the Technologies

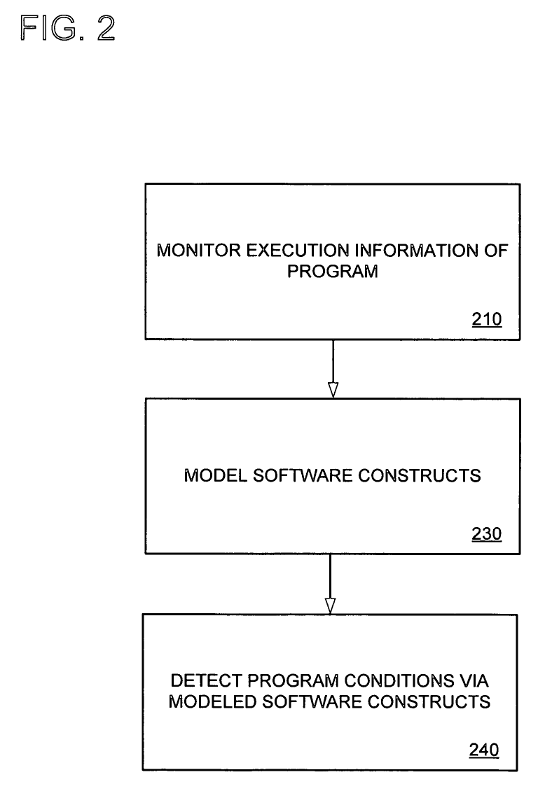

FIG. 2 is a flowchart of an exemplary method 200 of detecting a program condition and can be implemented, for example, in a system such as that shown in FIG. 1.

At 210, execution information of a program is monitored. For example, a stream of executed instructions can be monitored.

At 230, one or more software constructs are modeled. For example, modeling can be achieved via respective electronic representations of software constructs. The modeling can comprise updating the electronic representations of the software constructs based on monitoring the execution information (e.g., based on the executable instructions encountered in a stream of executable instructions).

At 240, one or more program conditions can be detected via the one or more respective electronic representations of the one or more software constructs.

### Example 3

### Exemplary Execution Information

In any of the examples herein, program execution information can provide details of an execution of a program. Such information can include a stream of executed instructions, read events, write events, calls, returns, and the like. Inside such information can be values for affected registers and memory locations, arithmetic operations, and other operations (e.g., object allocations/deallocations).

Execution information can be provided via a callback mechanism. So, for example, whenever an instruction is executed, a callback indicating the executed instruction can be provided to appropriate trackers described herein. Other events can similarly be provided.

Execution of a program can be performed on a native machine or a virtual machine. For example, execution on a virtual machine can emulate execution on a native machine (e.g., to analyze native code). Execution can be monitored live as it occurs or execution can be recorded for later playback, at which time the execution analysis is performed.

### Example 4

### Exemplary Software Constructs

In any of the examples herein, a software construct can include any mechanism used by a software program. For example, such constructs can include context switches, threads, heaps, calls, memory, data flow, references (e.g., pointers), instructions, an operating system, stacks, symbols, and the like. In practice, such constructs are simply digital data, but are often referred to as programmers via abstractions (e.g., a stack, which has a size, a top, and operations that can be performed on it). An abstraction (e.g., the top of the stack) can be referred to without replicating the entire object abstracted (e.g., the entire contents of the stack).

Modeling a software construct can include maintaining and providing information about the modeled software construct and operations on the modeled software construct, without necessarily completely replicating the modeled software construct. So, for example, when modeling a heap, some information (e.g., location of objects and how laid out in memory) can be stored in a model, while information (e.g., complete contents of an object) need not be.

Also, not all operations on the construct need be replicated. So, for example, when modeling a pointer, floating point operations on the pointer can be ignored if desired.

The extent of modeling can be varied based on the modeling goal. So, for example, if detailed information about pointers is desired, more detail can be stored regarding them than other values.

### Example 5

### Exemplary Program Conditions

In any of the examples herein, exemplary program conditions can include whether the program contains a defect (e.g., bug). Other program conditions can be any arbitrary criteria (e.g., whether a Boolean or other expression is satisfied).

For example, exemplary program conditions can include the presence of one or more memory leaks, the use of one or more dangling pointers, the use of one or more uninitialized values, violation of a condition set forth in a specification, and the like.

### Example 6

### Exemplary System for Detecting a Program Condition Using Trackers and Checkers

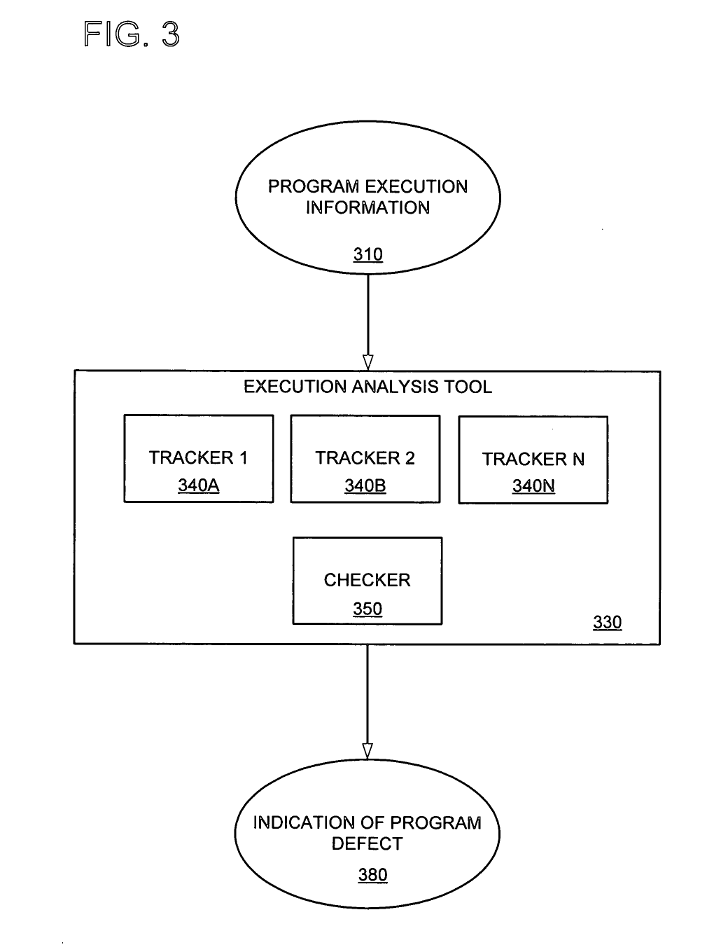

In any of the examples herein, an execution analysis tool for determining whether a program condition exists during execution of a program can use a combination of one or more trackers and one or more checkers. FIG. 3 shows an exemplary system 300 that includes a tool 330 that includes a plurality of trackers 340A-N and a checker 350. The trackers 340A-N can model software constructs as described herein.

In the example, program execution information (e.g., including a stream of executed instructions) 310 is processed by the tool to generate an indication of a program defect 380, if any.

### Example 7

### Exemplary Method of Detecting a Program Condition via Models

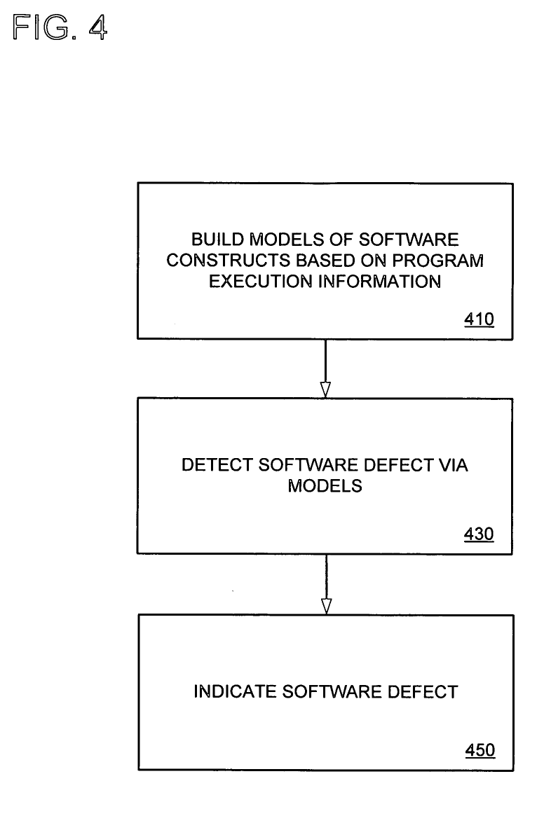

FIG. 4 is a flowchart of an exemplary method 400 generating an indication of a software defect via models of software constructs. At 410, models of one or more software constructs are built based on program execution information (e.g., by one or more trackers). At 430, a software defect is detected via the models (e.g., by one or more checkers). At 450, the software defect is indicated. For example, an indication of the software defect can be output. As described herein, accompanying information can also be provided for assisting in remedying the software defect (e.g., debugging the program).

### Example 8

### Exemplary Tracker

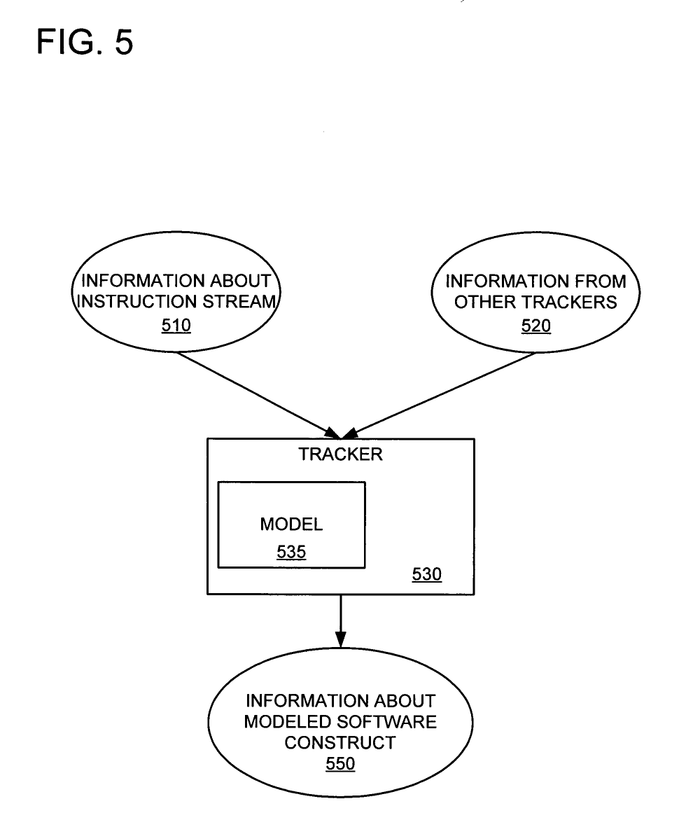

FIG. 5 is a block diagram of a system 500 including an exemplary tracker 530 configured to model one or more software constructs via a stored representation of one or more models 535. In the example, information about the executed instruction stream 510, information from one or more other trackers 520, or some combination thereof is used as input by the tracker 530 to maintain its model 535. The tracker 530 can provide information 550 about the modeled software construct.

As described herein, any number of trackers can be constructed to track a wide variety of software constructs. For example, trackers can model threads (e.g., context switches), a heap, calls to functions (e.g., object methods or the like), memory, data flow (e.g., of values such as pointers), instructions, an operating system (e.g., operating system function calls), call stacks, symbols, and the like.

Communication mechanisms between trackers and checkers can be varied as desired. For example, a call back mechanism can be used whereby a tracker or checker can subscribe to events by another tracker or checker, specifying criteria for event notification. So, for example, a tracker or checker can ask a call tracker to notify it whenever a call is made to a specified function. Upon detection by the call tracker that such a call has been made during execution of the program, the fact that the call was made and details regarding the call can be provided to the tracker or checker that has asked for such information.

Additionally, a tracker or checker can respond to direct requests for information. Or, a tracker or checker can perform a requested task on an ongoing basis (e.g., tagging data values) and report later on the results of the task.

### Example 9

### Exemplary Method of Modeling a Software Construct

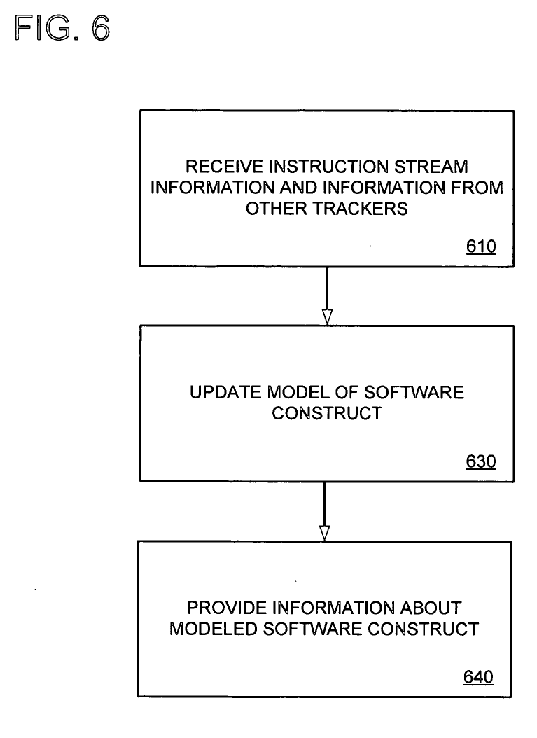

FIG. 6 is a flowchart of an exemplary method 600 for modeling a software construct and can be performed by any of the trackers described herein. In the example, information about the stream of instructions executed by the program, information from one or more trackers, or a combination thereof is received. At 630, the model of a software construct is updated based on the information received. At 640, information about the modeled software constructed is provided.

### Example 10

### Exemplary Checker

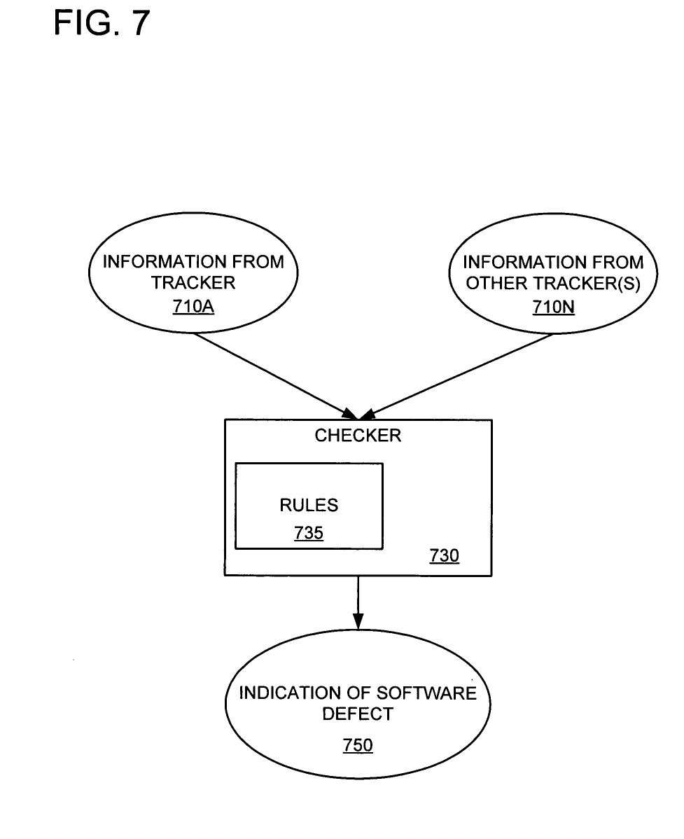

FIG. 7 is a block diagram of an exemplary system 700 including an exemplary checker for detecting a software defect via information provided by trackers. In the example, the checker 730 accepts information 710A-N from one or more trackers. The checker 730 applies rules 735 to detect a software defect and provide an indication 750 of the software defect.

### Example 11

### Exemplary Method of Applying Rules to Detect Software Defect

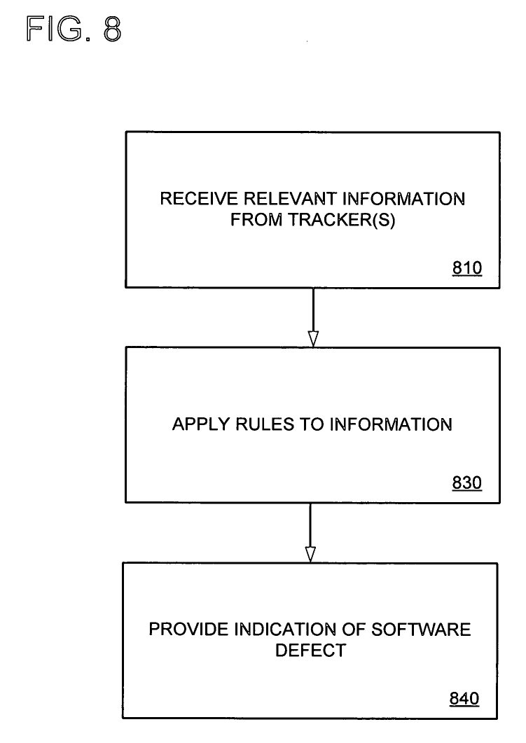

FIG. 8 is a flowchart of an exemplary method 800 of identifying a software defect in a program via rules and can be implemented, for example, in a system such as that shown in FIG. 7. At 810, information from one or more trackers is received. At 830, rules are applied to the received information. Responsive to detecting a software defect, an indication of the software defect is provided at 840.

The rules can be specified in hard-coded logic (e.g., logic that determines whether there is a memory leak), a scripting language, a configurable list of conditions, or some other mechanism that can be changed as desired to specify custom conditions.

### Example 12

### Exemplary Analysis System Employing Trackers and a Checker

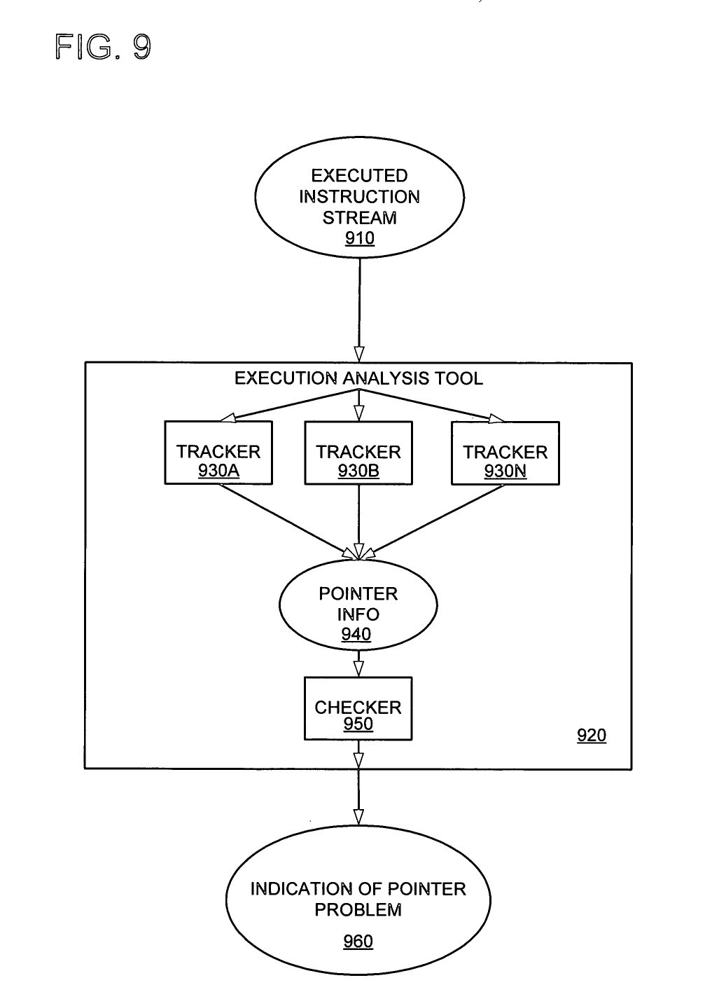

FIG. 9 is a block diagram of an exemplary system 900 employing trackers 930A-N and a checker 950 to identify a software defect relating to pointers in a program (e.g., a memory leak, dangling pointer use, or the like). In the example, an execution analysis tool 920 accepts information about an execution of the program being tested (e.g., an executed instruction stream) 910.

The tool 920 employs a variety of trackers 930A-N to derive pointer information 940 (e.g., information about the use and storage of pointers to objects). A checker 950 analyses the pointer information 940 to determine whether there is a pointer problem. If so, an indication 960 of the pointer problem is provided.

Other information can be provided to assist in debugging (e.g., the call stack at the time the pointer was allocated, the call stack at the time the problem was detected, and the like).

In practice, there can be a different number of trackers, and they can be arranged in parallel, in series, or some combination thereof. The pointer information 940 can be provided as requested by the checker 950 or sent by one or more trackers 930A-N (e.g., when it becomes available).

### Example 13

### Exemplary Method of Identifying a Pointer Problem

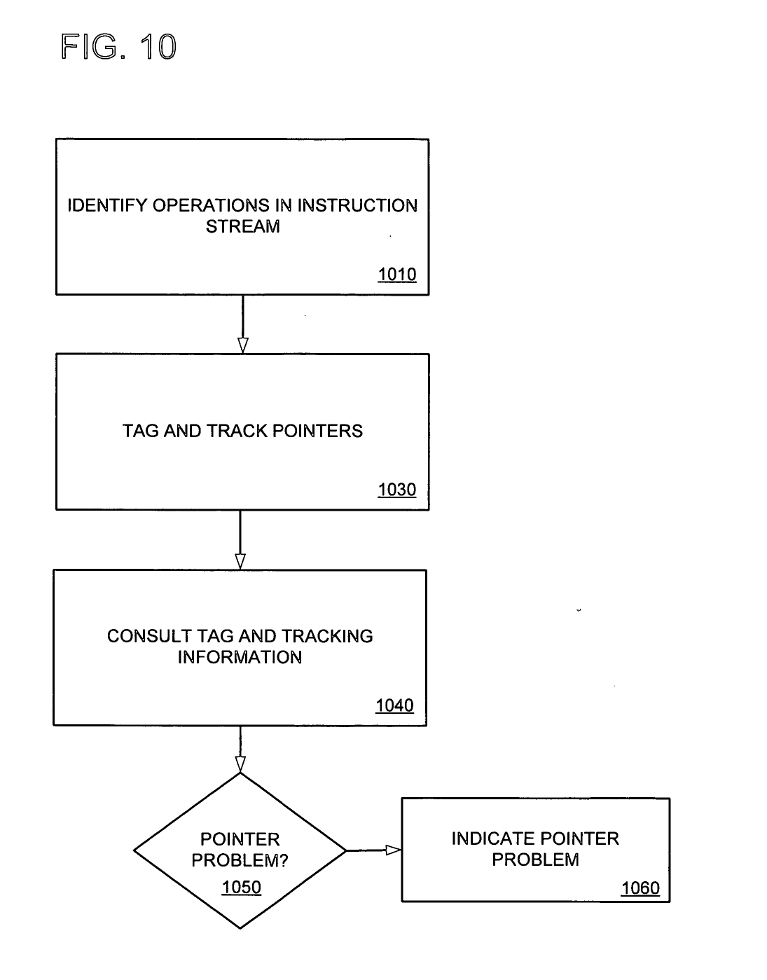

FIG. 10 is a flowchart of an exemplary method 1000 of identifying a software defect relating to pointers in a program. At 1010, operations in an executed instruction stream are identified. For example, pointer operations such as pointer copies, arithmetic operations on pointers, pointer creation (e.g., allocations), and the like can be identified. At 1030, pointers are tagged and tracked. For example, if a value is identified as a pointer, it can be tagged (e.g., identified as to be tracked). Tagged values can be tracked (e.g., arithmetic operations can be analyzed, an algebra can be applied, and the like) as pointers to determine their use, lifetime, history, and the like.

At 1040, the tag information, the tracking information, or both can be consulted to determine whether there is a pointer problem. At 1050, if there is a pointer program, the pointer problem can be indicated (e.g., as a software defect). If desired, the pointer history can also be indicated.

### Example 14

### Exemplary Data Flow Tracker

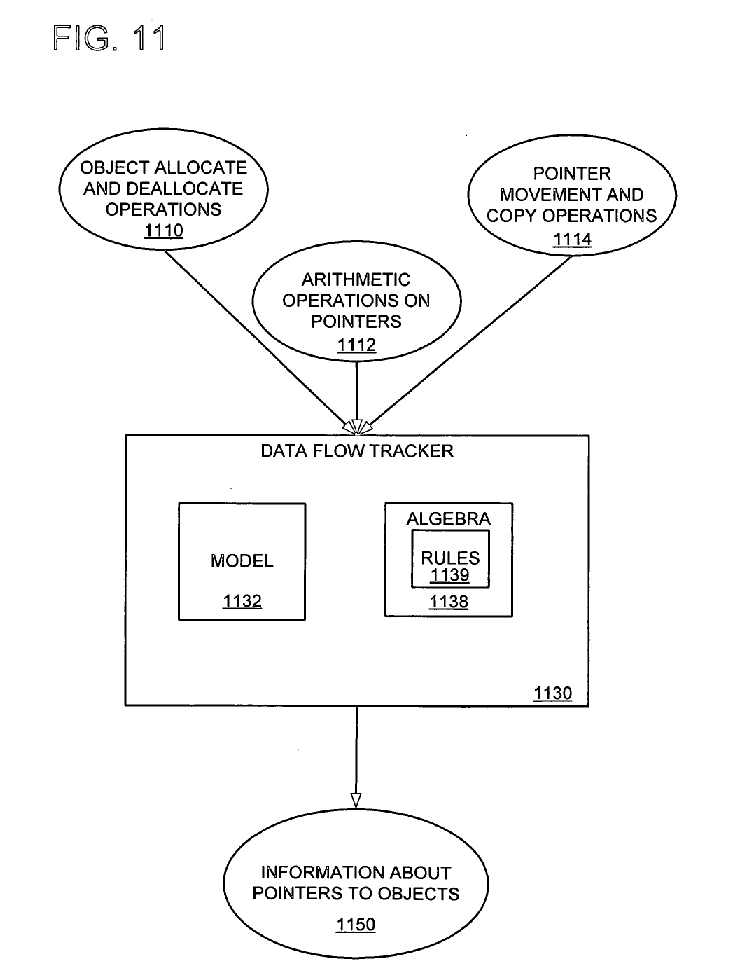

FIG. 11 is a block diagram of a system 1100 that includes an exemplary data flow tracker 1130. Because the data flow tracker can track values (e.g., pointers and the like), it is sometimes called a “value tracker.” If desired, some values can be tagged as of interest, and only those values need to be tracked. For example, during an allocation, the contents of a particular register (e.g., EAX) may indicate a pointer to a heap object. The register can be tagged as being of interest, and the data flow tracker will track the movement of the value throughout the analyzed system (e.g., on the stack, into other registers, memory on the heap, and the like).

In the example, the data flow tracker 1130 can accept information gleaned from an executed instruction stream, such as object allocation and deallocation (e.g., free) operations 1110, arithmetic operations on pointers 1112, and pointer movement and copy operations 1114.

The data flow tracker 1132 can represent values that are tracked via a model 1132. For example, values, symbols, or both can be stored for values (e.g., pointers). The dataflow tracker 1130 can employ an algebra 1138 comprising algebraic rules 1139 to handle various arithmetic operations on pointers. Although shown as internal to the data flow tracker 1132, the algebra 1138 can be implemented as a separate mechanism (e.g., shared by other trackers).

The data flow tracker 1130 can provide information 1150 about pointers to objects. For example, the data flow tracker can follow pointers throughout the program and indicate where a pointer has been copied, how many copies of it still exist, the location of such copies (e.g., whether they are in the heap or not), and the like. The data flow tracker can indicate how many pointers (e.g., how many copies or derived copies) there are to any of the objects tracked. Such information can be provided indirectly, such as by providing a notification whenever another copy of the pointer is created and whenever a copy is destroyed (e.g., erased, overwritten, or leaves the stack). If needed, the data flow tracker 1130 can call on one or more other trackers or receive information from one or more other trackers to obtain information to fulfill requests. For example, the data flow tracker 1130 can receive a notification that the stack reduces in size. In response, the data flow tracker 1130 can treat any tagged values that were on the stack as destroyed (e.g., for reference counting purposes).

In some cases, it may be desirable to split off functionality related to pointers (e.g., reference counting) into a separate tracker, which can work in conjunction with the data flow tracker (e.g., to track the number of pointers to an object).

### Example 15

### Exemplary Method of Tracking Pointers

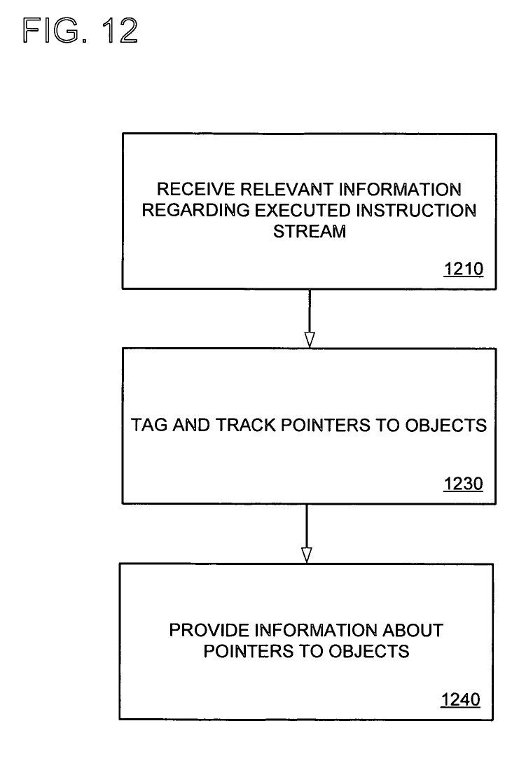

FIG. 12 is a flowchart of an exemplary method 1212 of tracking pointers and can be implemented, for example, by a tracker such as that shown in FIG. 11. At 1219, information regarding an executed instruction stream of a program being tested is received. At 1230, pointers to objects are tagged and tracked. At 1240, information about pointers to objects is provided. Such information can include an indication of a defect in the program.

### Example 16

### Exemplary Pointer Tracking

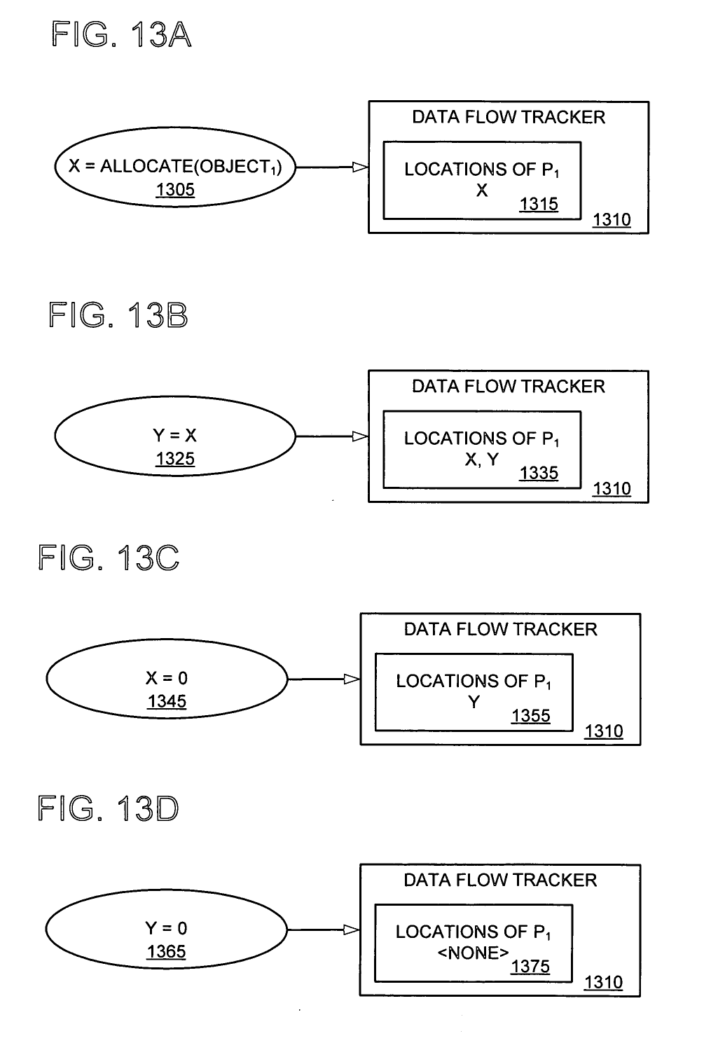

FIGS. 13A-D are block diagrams showing a data flow tracker tracking pointers to an object. Such pointers can be tracked as they are stored in memory locations, registers, and the like.

Initially, at 1300, the data flow tracker 1310 receives an indication 1305 that memory has been allocated (e.g., on the heap) for an object. The allocation function returns a pointer to the object, X. The data flow tracker 1310 thus recognizes that a new pointer, called P₁ in the example, has been created and tracks the locations 1315 of the pointer (e.g., it is tagged). So far, there is only one location of the pointer, in X. In practice, different mechanisms or notations can be used for indicating the pointers and their locations.

At 1320, the data flow tracker 1310 detects that an assignment operation 1325, Y=X, has been executed. The pointer P₁ has thus been copied to another location, Y. The tracked locations 1335 thus now include X and Y.

Subsequently, at 1340, the data flow tracker 1310 detects that an assignment operation 1345, X=0, has been executed. The pointer P₁ has thus been erased from location X. The tracked locations 1355 now include only Y.

Then, at 1360, the data flow tracker 1310 detects that another assignment operation 1365, Y=0, has been executed. The pointer P₁ has thus been erased from its last remaining location, Y. The tracked locations 1375 now indicate that there are no remaining copies of the pointer P₁.

When queried, the data flow tracker 1310 can indicate that there are no remaining copies of the pointer P₁. In such a case, if the memory has not been deallocated, a memory leak has been indicated by a simple rule set. In practice, more complex logic can be applied to detect memory leaks as described herein.

### Example 17

### Exemplary Instruction Tracker

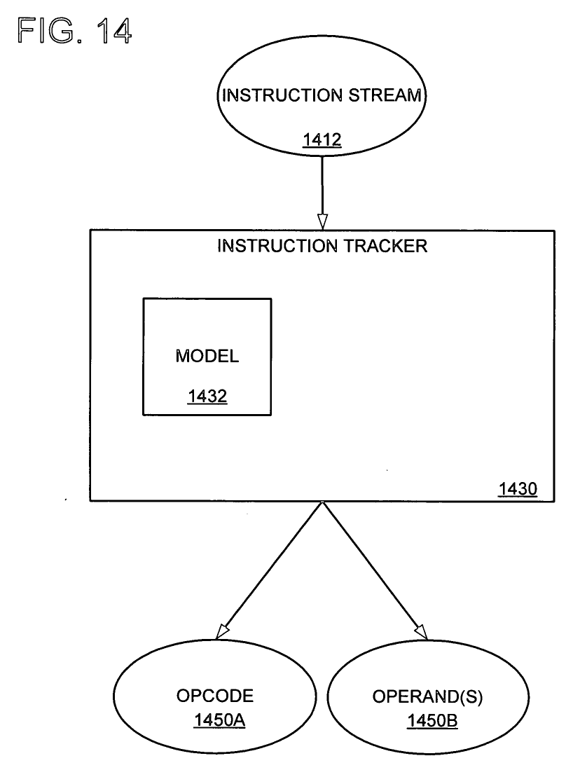

FIG. 14 shows an exemplary system 1400 including an exemplary instruction tracker 1430. An instruction tracker 1430 can be included in any of the systems described herein to process an executed instruction stream 1412 of a program under test. A disassembler (not shown) can also be used to determine what an instruction does (e.g., what registers are involved, what read and writes it does, and the like) and route it to other trackers, as appropriate.

For sake of brevity, the instruction tracker and disassembler may be implied and need not be shown on all system diagrams. In some cases, some instructions (e.g., floating point operations) need not be tracked.

The model 1432 employed by the instruction tracker 1430 may simply model the incoming instructions (e.g., an opcode, sources, and destinations). The tracker 1430 itself can provide the opcode 1450A and operands 1450B for instructions in the instruction stream 1412. Other checkers can subscribe to events from the instruction tracker 1430, or some other mechanism can be used to communicate the instructions to other trackers.

### Example 18

### Exemplary Call Tracker

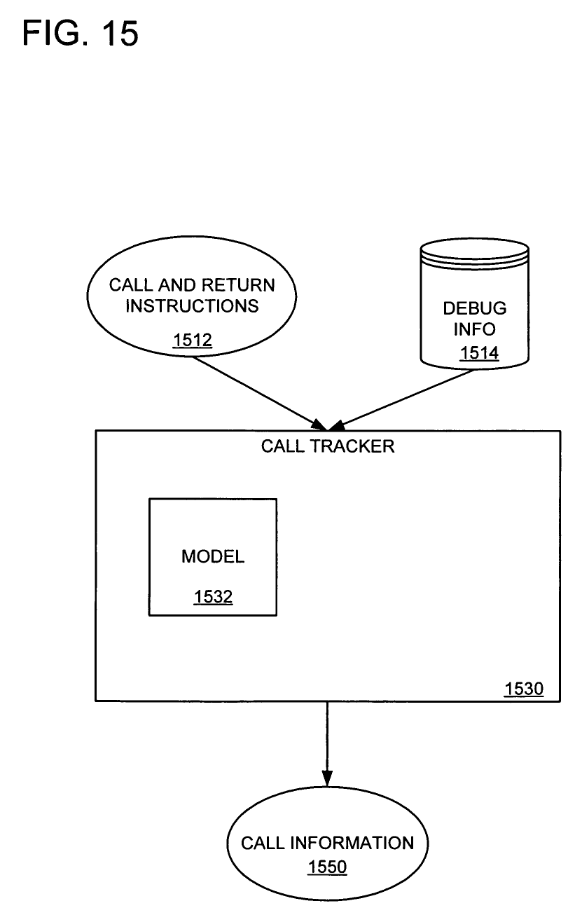

FIG. 15 shows an exemplary system 1500 that includes an exemplary call tracker 1530 that can be used in any of the analysis tools described herein. The call tracker 1530 can determine when a call is made to a particular function and notify other trackers when such a call is made.

In the example, the call tracker 1530 receives call and return instructions 1512 (e.g., from an instruction tracker) and debug information 1514 (e.g., a program database (pdb) file or the like), which includes symbol information (e.g., the names of functions that are being called). In practice, a separate tracker called a “symbol tracker” can provide the symbol information from the debug information. In any of the examples herein, trackers can be split into two or combined as desired for development purposes.

The call tracker 1530 can consult the symbol information to determine when a particular function (e.g., malloc( ), heapalloc( ), free( ), and the like) is being called and notify other trackers (e.g., which have subscribed to events from the call tracker 1530 for calls to the function). The model 1532 can simply be the name of the function and may also include operands to the function (e.g., zero or more sources and zero or more destinations).

The call information 1550 can be provided as appropriate (e.g., to other trackers) and include the modeled information (e.g., the name of the function and operands). The call tracker 1530 can also track the current contents of the call stack.

### Example 19

### Exemplary Heap Tracker

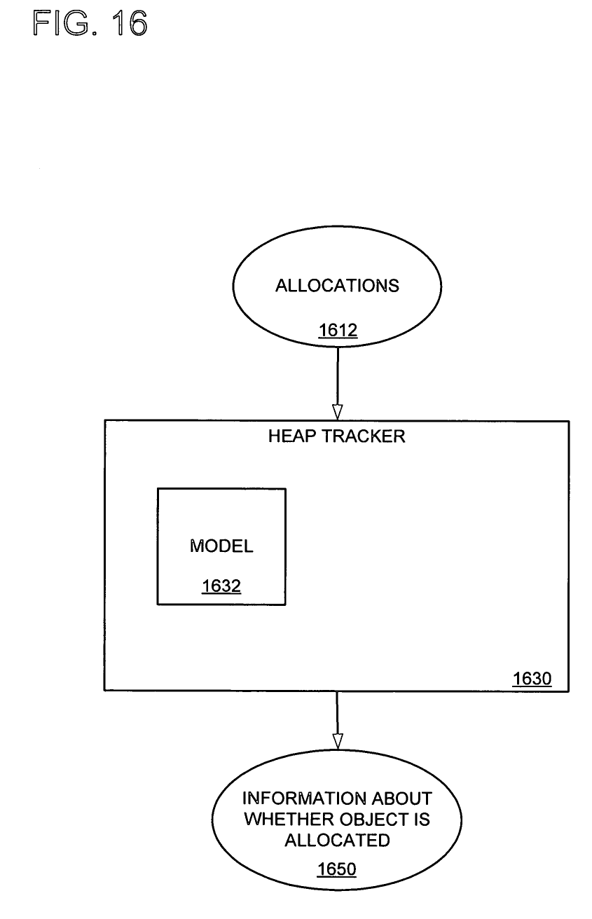

FIG. 16 shows an exemplary system 1600 that includes an exemplary heap tracker 1630 that can be used in any of the analysis tools described herein. In the example, the heap tracker 1630 receives information 1612 about instructions that manipulate the heap, such as allocations and deallocations on the heap (e.g., creation and destruction of objects). The heap tracker can receive information as a result of providing a list of functions (e.g., heapalloc( ) and the like) to a call tracker, which will notify the heap tracker whenever calls are made to the functions.

The tracker 1630 can use its model 1632 to represent what objects are present on the heap, how they are laid out in memory, the addresses of objects on the heap, the size of the objects, and the like. Various other information 1650 about the heap (e.g., whether an object is allocated or not, when it was allocated, the call stack when it was allocated, and the like) can be tracked and provided if desired when reporting a defect to assist in remedying the defect.

### Example 20

### Exemplary Memory Tracker

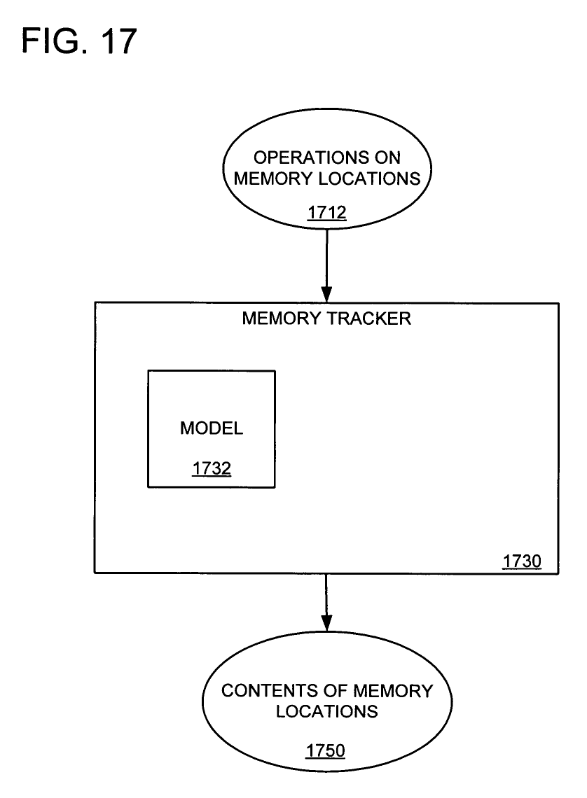

FIG. 17 shows an exemplary system 1700 that includes an exemplary memory tracker 1730 than can be used in any of the analysis tools described herein. In the example, the memory tracker 1730 receives information 1712 about operations on memory locations (e.g., reads and writes to memory and the like). The tracker 1730 can use its model 1732 to represent values in memory, and the like. Various information 1750 about memory (e.g., the value of a memory location, when the value was stored, and the like) can be provided. For example, a heap tracker can request information about arguments to an operation on the heap from the memory tracker 1730. In practice, the memory tracker 1730 can also track register contents if desired.

### Example 21

### Exemplary Thread Tracker

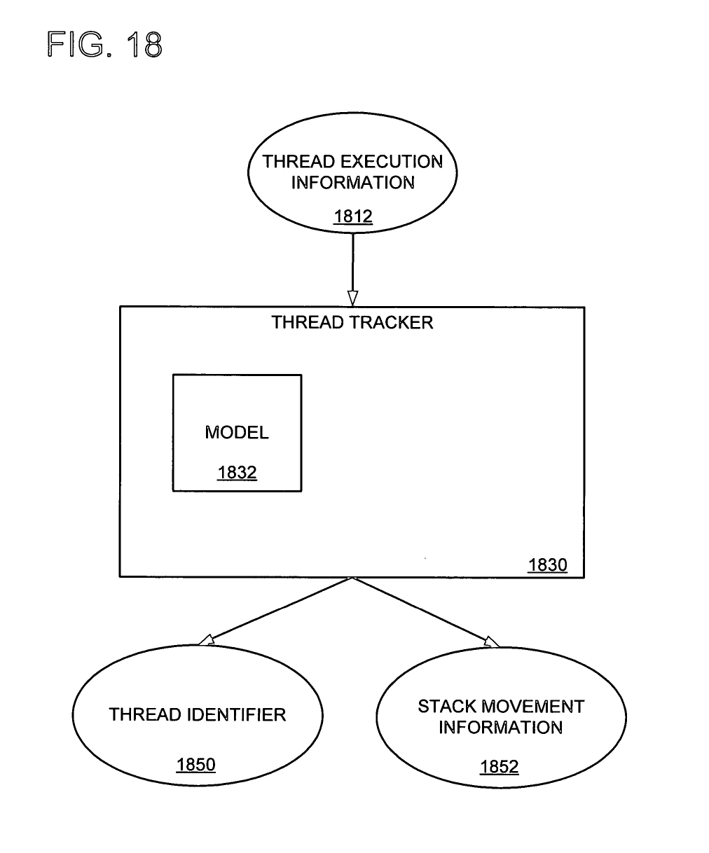

FIG. 18 shows an exemplary system 1800 that includes an exemplary thread tracker 1830 than can be used in any of the analysis tools described herein. In the example, the thread tracker 1830 receives information 1812 related to threads, such as when a thread starts executing (e.g., due to a thread context switch) and the like.

The tracker 1830 can use its model 1832 to represent unique identifiers for threads, call stacks for threads and the like. Various information 1850 about threads (e.g., the thread identifier, a notification when a different thread starts executing, and the like) can be provided. Thread identifiers can be useful to help other trackers perform tracking on a per-thread basis.

In practice, the thread tracker 1830 can also track the call stack (e.g., per thread) and so it can also provide stack movement information 1852. When the stack moves (e.g., the stack reduces in size), it can be communicated as a stack free operation because the contents of the stack are essentially deallocated. The call stack can instead be tracked by a separate tracker.

### Example 22

### Exemplary Call Stack Tracker

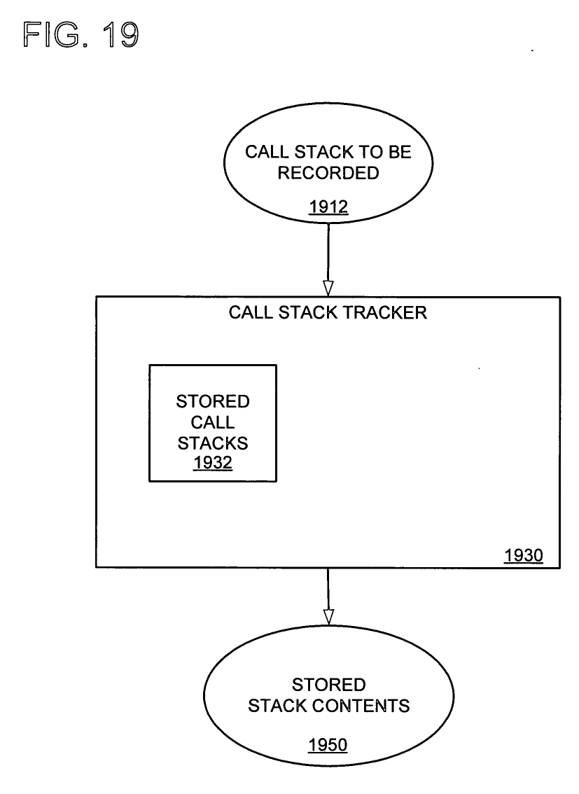

FIG. 19 shows an exemplary system 1900 that includes an exemplary call stack tracker 1930 than can be used in any of the analysis tools described herein. In some cases, it may be desirable to perform a large number of call stack store operations. When providing information about program execution and defects to a human software developer, providing the call stack is a useful way to describe the program. For example, the call stack at the time the defect occurs, at the time the object in question was allocated, and the like can be provided to assist in debugging. However, a very large number of call stack store operations may thus be performed during analysis of a program. Because many of the call stacks may be identical, techniques described herein can be used in the call stack tracker 1930 to reduce storage and processing resources needed to store the call stacks.

In the example, the call stack tracker 1930 receives a plurality of call stacks to be recorded 1912. The call stack tracker stores the call stacks 1932, and can provide the stored call stack 1950 when requested at a later time.

An exemplary use of the call stack tracker 1930 is to provide call stack storage services to a heap tracker, which wishes to store the call stack (e.g., whenever an object is created). The heap tracker can request the call stack from the call tracker and store it via the call stack tracker. Subsequently, if a defect is detected, the stored call stack can be provided to assist in debugging the defect.

### Example 23

### Exemplary Method of Storing Call Stacks via Hash

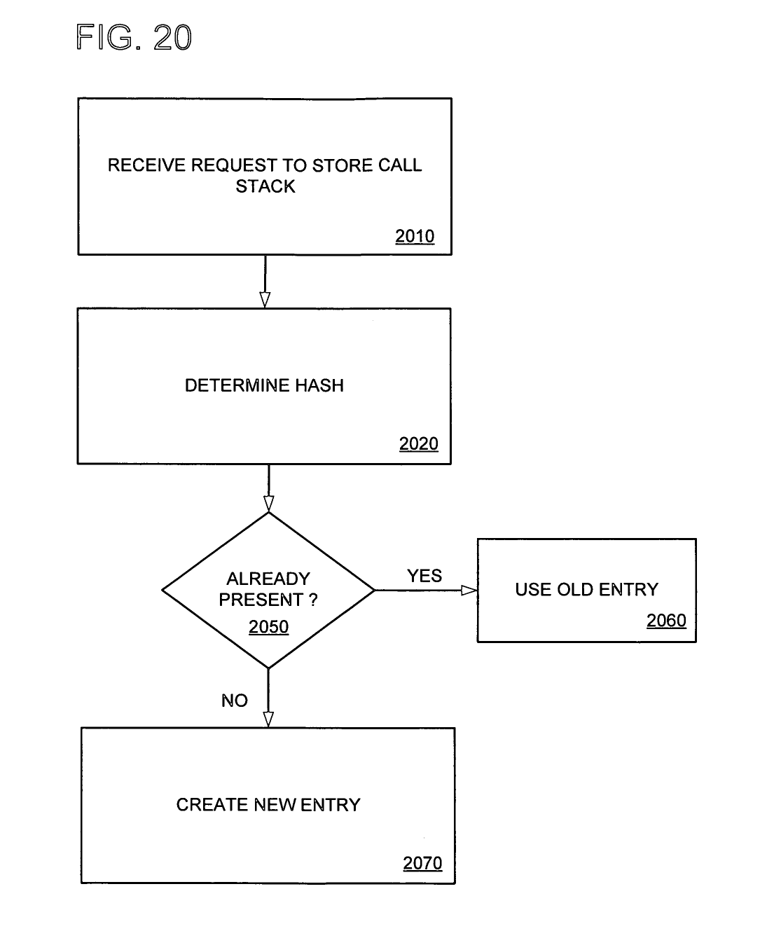

FIG. 20 shows an exemplary method 2000 of storing call stacks via a hash and can be used in any of the examples herein that store call stacks. At 2010, a request to store a particular call stack is stored. At 2020, a hash is computed for the call stack (e.g., by XORing return addresses or some other function). At 2050, it is determined whether the call stack is already present in the stored call stacks. If so, a pointer to the old entry is used at 2060. Otherwise, a new entry can be created and used at 2070. Hash collisions can be taken into account.

In some cases, a table relating objects to various call stacks can be stored. Then, when a request for the call stacks related to an object is received, the associated call stacks can be provided.

In addition to using the hash technique, storage resources can be conserved by indicating that a part of a call stack is identical to a call stack already stored. So, for example, if most of the call stack is identical to another except for a first part, the first part can be stored, and the remainder of the call stack can be indicated as identical to another call stack (e.g., via a reference to the other call stack) instead of storing it again. For example, the call stacks can be stored as a call tree.

### Example 24

### Exemplary Arrangement of Storing Call Stacks via Hash

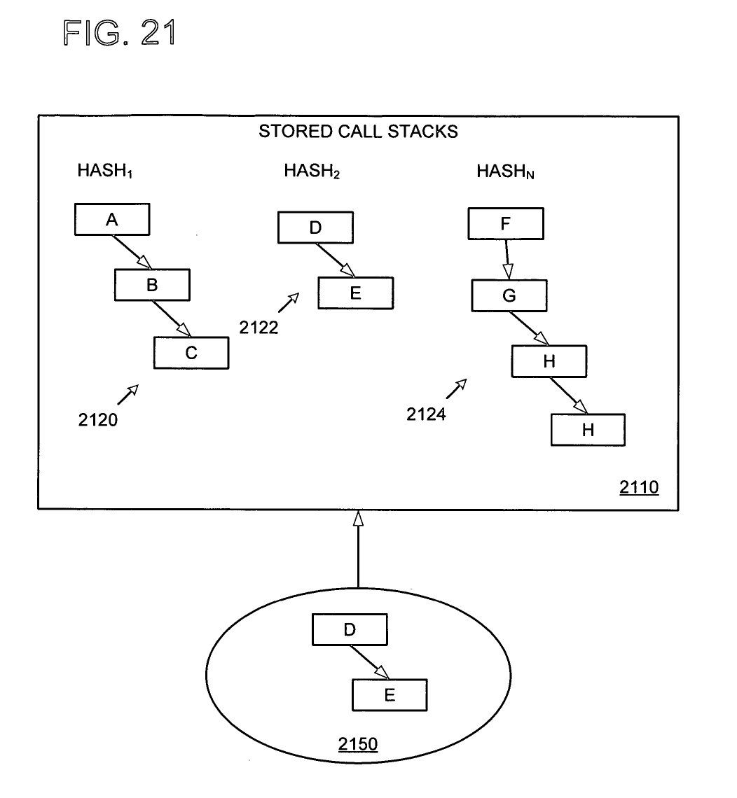

FIG. 21 shows an exemplary arrangement 2100 of storing call stacks via a hash. In the example, various call stacks 2120, 2122, 2124 are stored as stored call stacks 2110 and associated with hashes hash₁, hash₂, and hash₃, respectively. Although not shown, the call stacks 2120, 2122, 2124 can be stored as a call tree instead of being separately shown (e.g., in practice, the call stacks can have a common root).

When a call stack to be recorded 2150 is received, a hash is computed for the call stack 2150. In the example, the hash will match hash₂, and it is discovered that the call stack has already been stored before as call stack 2122. So, the call stack need not be stored again. Instead, a reference (e.g., pointer) to the call stack 2122 can be stored. In practice, there can be many call stack store operations, and call stacks can be of much larger lengths, so the savings can be significant.

### Example 25

### Exemplary System for Detecting a Memory Leak

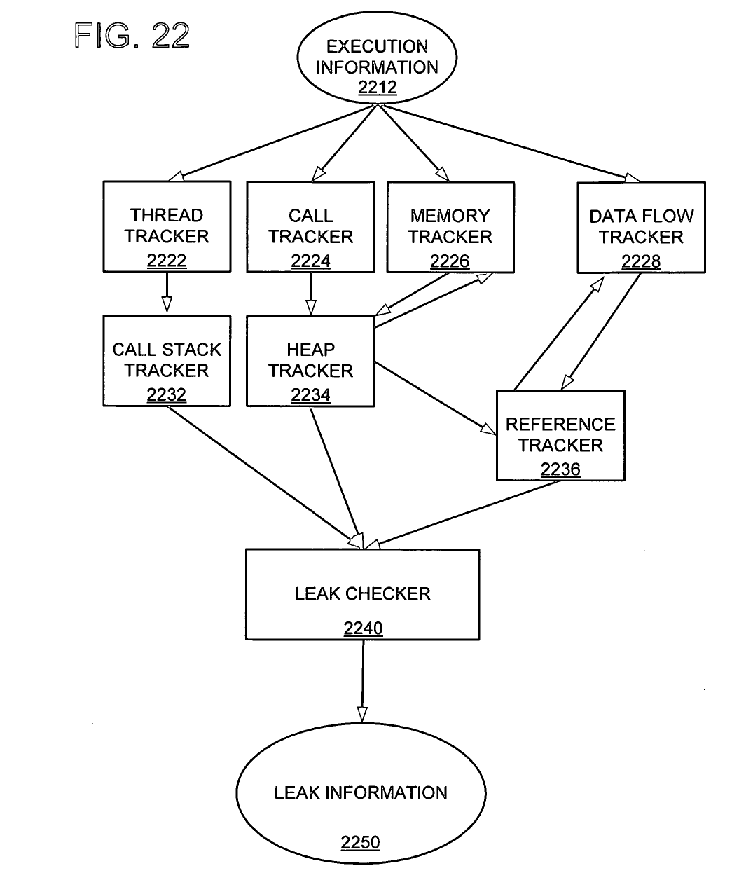

FIG. 22 shows an exemplary system 2200 employing trackers 2222, 2224, 2226, 2228, 2232, 2234, 2236 and a checker 2240 to detect a memory leak. In the example, the execution information 2212 is fed to the thread tracker 2222, the call tracker 2224, the memory tracker 2226, and the data flow tracker 2228. These in turn provide information to a call stack tracker 2232, a heap tracker 2234, and a reference tracker 2234 (e.g., specifically for tracking pointers, such as the number of pointers to an object).

The trackers provide information to the leak checker 2240, which can provide an indication 2250 when a memory leak is detected. Additional information related to the software defect can be provided as described herein. In practice, additional checkers can be used, the checkers can be otherwise arranged (e.g., checkers can be combined, checkers can be split, or both), or both.

### Example 26

### Exemplary Method for Detecting a Memory Leak

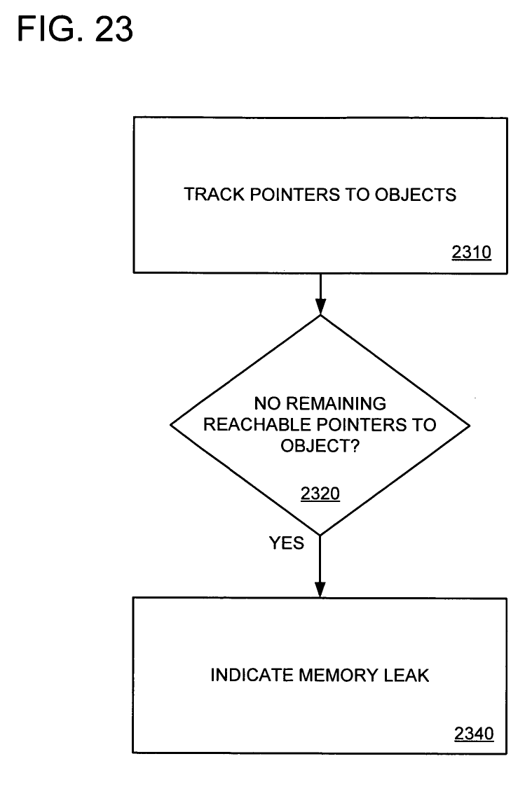

FIG. 23 shows an exemplary method 2300 for detecting a memory leak. In the example, pointers to objects are tracked (e.g., via any of the examples described herein). At 2320 it is determined whether there are any remaining reachable pointers to a particular object (e.g., whether the reference count on an object goes to zero). If the condition is met, at 2340, a memory leak is indicated. Additional information related to the software defect can be provided as described herein.

As described herein, a more complex rule can be used that takes into account a cluster of objects to which there are no references. Garbage collection technologies can be used to detect a memory leak. If the object can be garbage collected (e.g., no references remain), it is a leak. However, the determination can be done for native code if desired, whereas garbage collection is conventionally carried out for managed code (e.g., code with managed pointers that cannot be accessed directly as they can be in native code).

### Example 27

### Exemplary Memory Leak Scenarios

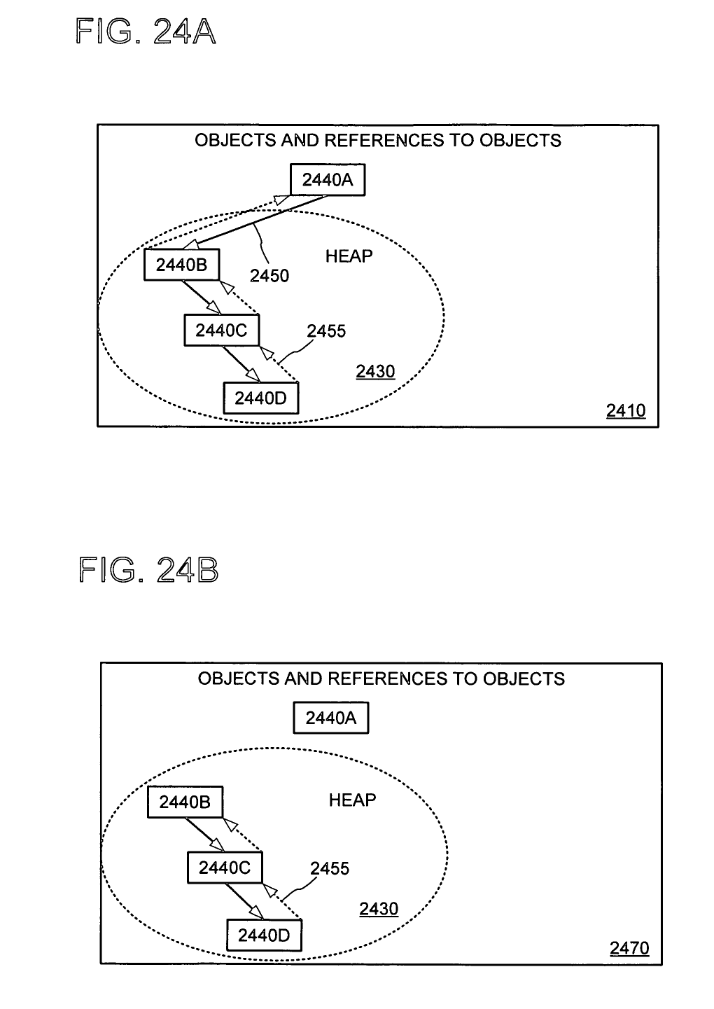

FIGS. 24A-B are block diagrams showing examples of detecting whether a memory leak has occurred during execution of a program. In the example, the condition of whether or not an object can be reached from an object not on the heap (e.g., on the stack, a register, a global, or the like) is used. If so, a memory leak is indicated. At 2400, objects and references to objects 2410 include objects 2440A-D. The heap includes the objects 2440B-D. Pointers (e.g., the pointer 2450) connect the objects, so that all objects are reachable from outside the heap 2430 (e.g., via the object 2440A). For purposes of tracking, reverse pointers (e.g., the pointer 2455) are maintained (e.g., by a value or reference tracker).

At 2460, objects and references to objects 2470 include the same objects 2440A-D. The heap similarly includes the same objects 2440B-D. One of the pointers (e.g., the pointer 2450) has been removed, so that the objects are no longer reachable from outside the heap 2430. The condition can be detected via the back pointers (e.g., the pointer 2455). A memory leak is thus indicated.

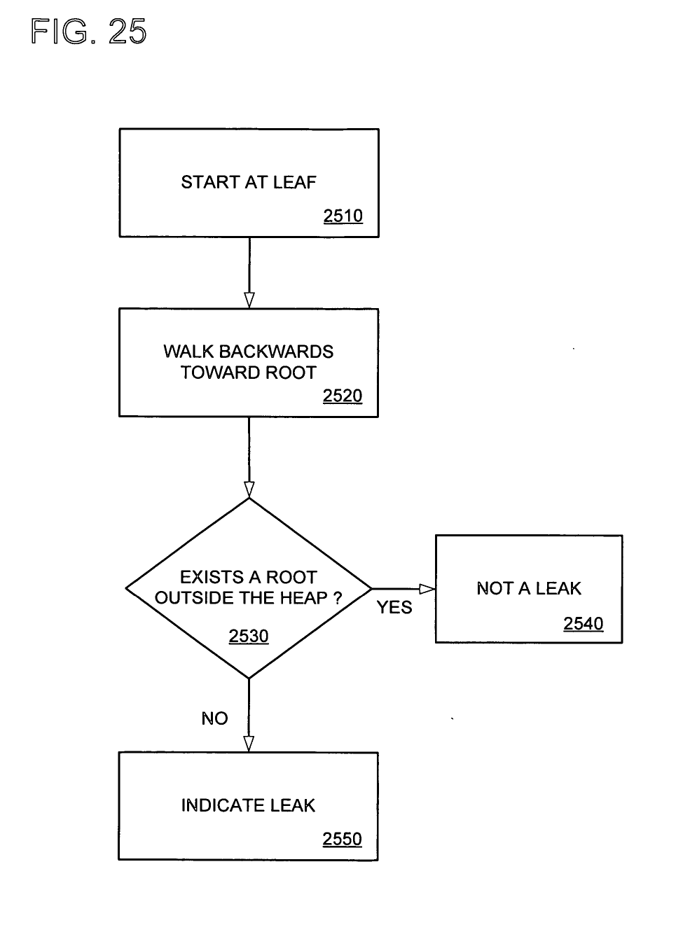

FIG. 25 shows an exemplary method 2500 for detecting whether a memory leak has occurred during execution of a program. The method can be used in conjunction with the arrangement shown in FIG. 24. The method can be performed per object, although some savings can be achieved by determining whether an object has been traversed during checking another object. At 2510, the method starts at a leaf and walks backwards toward a root at 2520 (e.g., via the back pointers described).

At 2530, it is determined whether a root outside the heap exists. If so, no leak is indicated at 2540, otherwise a leak is indicated at 2550. Depth- or breadth-first techniques can be applied, and cycles can be accounted for. To avoid performance degradation (e.g., due to very long list), a cap can be placed on the number of traversals during the walk.

Such an approach can detect leaks better than simply seeing if the reference count (e.g., number of pointer copies) is zero. For example, if three objects are pointing to each other in a cycle, each has a reference count of one. But if no pointers outside the heap are pointing to any of the three, they are all three leaked.

Upon detection of deallocating an object (e.g., calling free( ) for the object), the data flow tracker can be notified (e.g., so that it knows to no longer track it), and whatever is tracking pointers (e.g., the data flow tracker or the reference tracker) can be notified (e.g., to determine whether it results in a leak).

Techniques can be applied to prevent a false positive due to what temporarily appears to be a memory leak. For example, deallocations can be processed in an order that avoids indicating a memory leak when a group of objects (e.g., during a whole heap deallocation) is being deallocated (e.g., to process deallocations of the pointed to objects first before processing the deallocation of the object with the root pointer).

### Example 28

### Exemplary Information Provided to Indicate a Memory Leak

In any of the examples herein, in addition to providing an indication that a memory leak has occurred, additional information can be provided to assist in debugging the memory leak. For example, the information can include the leaked object, the call stack when the leaked object was allocated (e.g., and the time it was allocated), the call stack when the last reference was lost (e.g., and the time), a pointer to the leaked object, and the like.

The information can be provided in XML according to a schema and loaded up into a debugger for assistance during the debugging process.

### Example 29

### Exemplary Additional Complexities in Memory Leak Scenarios

The technologies described herein can be used to detect complex memory leak scenarios. For example, if exclusive or (XOR) operations are performed on pointers (e.g., during navigation of a linked list), the trackers described herein can determine (e.g., via an algebra) if a pointer is reconstructed. So, for example, it may appear that the reference count on an object has dropped to zero, but the pointer may reappear at a later time (e.g., due to the XOR operation).

Because the technologies described herein can address such situations, the execution analysis tool can be configured to detect any of the pointer problems described herein in scenarios involving arithmetic operations (e.g., XOR) performed directly on pointers. Because such operations are performed in many native code programs, the technologies described herein can be used to detect defects in such native code.

### Example 30

### Exemplary Algebra

In any of the examples described herein, an algebra can be applied to assist in detecting a software defect. The algebra can include algebraic rules that specify equivalent expressions and possible actions to take when such expressions are encountered. Such an algebra can be helpful when tracking pointers, tracking when a value is uninitialized, and the like.

Table 1 shows application of a set of exemplary algebraic rules. Rules can be applied for addition, subtraction, multiplication, division, shifting, Boolean operations (e.g., AND, OR, XOR, NOT, etc.), and the like.

The rules can be useful for reconstructing pointer values. Arithmetic manipulations of a pointer (e.g., adding one to a pointer) may result in a new pointer that can be tracked. However, in some cases, an old pointer is reconstructed, or the pointer is destroyed. Rules 1 and 2 of the Table illustrate how a rule can reconstruct a pointer value P₁ when a value is added and subtracted to it. Rules 2 and 3 illustrate how a rule can reconstruct a pointer value P₁ when a value is XORed to it. Rule 5 illustrates how a rule can determine that a pointer no longer exists (e.g., the reference count can be reduced) when a reflexive XOR is applied. Rule 6 illustrates how a shift operation can indicate that the contents of a high order byte of a storage location should be tracked responsive to determining that the shift operation has placed data into an area that may have not been tracked before (e.g., in a scenario where high and low order bytes are separately tracked).

TABLE 1
Exemplary Application of Algebraic Rules

| Rule | Start | Operation | Result | Reduction |
|---|---|---|---|---|
| 1 | P₁ | +X | P₁ + X | None |
| 2 | P₁ + X | −X | P₁ + X − X | P₁ |
| 3 | P₁ | XOR P₃ | P₁ XOR P₃ | None |
| 4 | P₁ XOR P₃ | XOR P₃ | P₁ XOR P₃ XOR P₃ | P₁ |
| 5 | P₁ | XOR P₁ | P₁ XOR P₁ | 0 (stop tracking) |
| 6 | P₁ | <<24 bits | P₁ << 24 bits | none |
| | | | | (tag high byte) |

In practice, additional rules can be used. A separate algebra may be appropriate for different defect detection scenarios, or a generalized algebra can be constructed to apply to more than one scenario. In some cases, an expression may be encountered that is determined to be too complex for appropriate reduction. In such a case, the value in question may be dropped for further tracking (e.g., and an indication can be made that such an expression was encountered, providing details to the user if desired).

### Example 31

### Exemplary System for Detecting Use of an Uninitialized Value

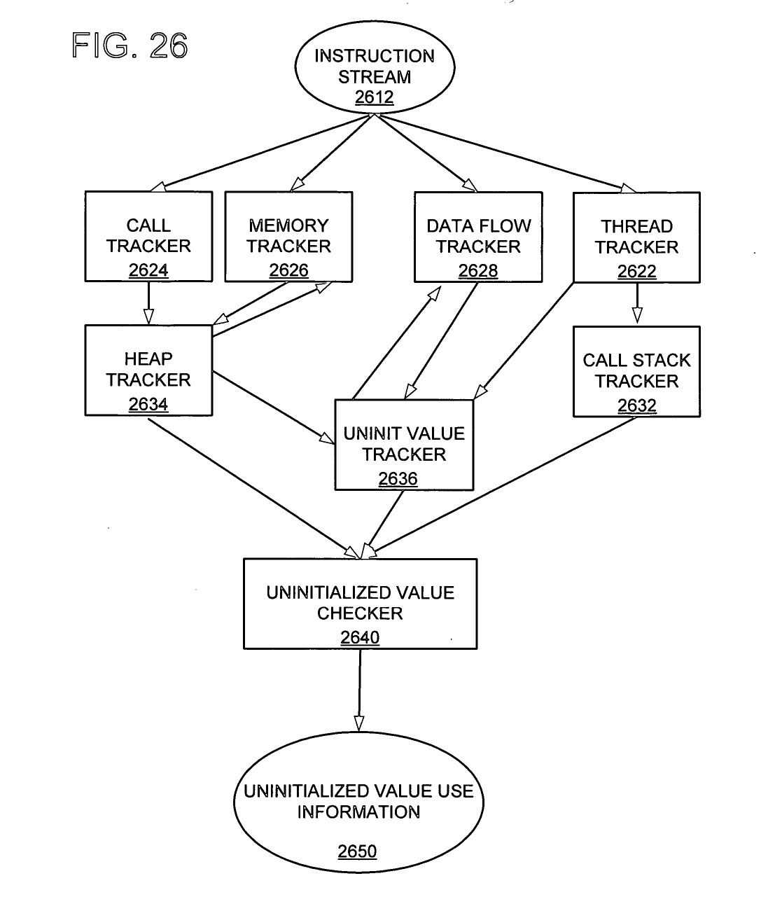

FIG. 26 shows an exemplary system 2600 employing trackers 2622, 2624, 2626, 2628, 2632, 2634, 2636 and a checker 2640 to detect a use of an uninitialized value based on the instruction stream 2612. The trackers 2622, 2624, 2626, 2628, 2632, 2634, 2636 can be configured similarly to those for the memory leak system shown in FIG. 22. In addition, an uninitialized value tracker 2636 can receive information (e.g., stack allocations/frees) from the thread tracker 2632.

An uninitialized value checker 2640 can process the information from appropriate trackers to indicate uninitialized value use information 2650 (e.g., the location of a value that was used before it was initialized). In the case of memory or an object, such information 2650 can include when the memory or object was allocated. In practice, additional checkers can be used, the checkers can be otherwise arranged (e.g., checkers can be combined, checkers can be split, or both), or both.

### Example 32

### Exemplary Method for Detecting Use of an Uninitialized Value

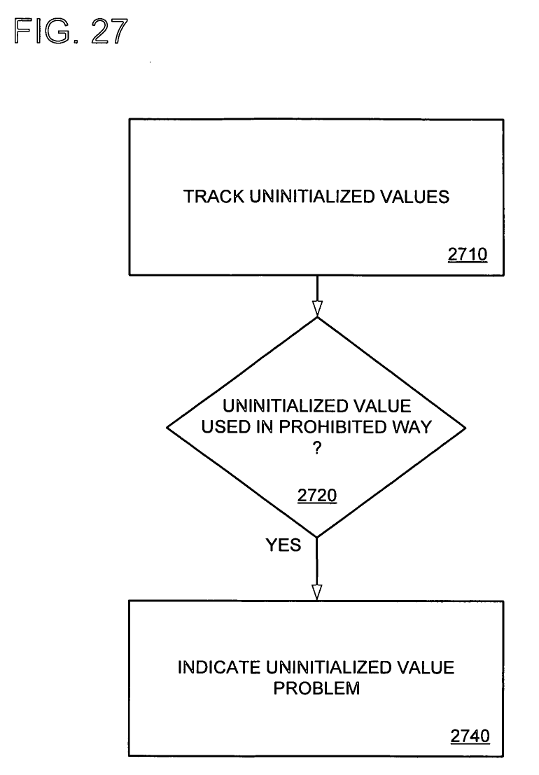

FIG. 27 shows an exemplary method 2700 for detecting use of an uninitialized value. In the example, uninitialized values are tracked (e.g., via any of the examples described herein). At 2720 it is determined whether an uninitialized value is used in a prohibited way (e.g., as a pointer to an object). If the condition is met, at 2740, an uninitialized value problem is indicated.

Whenever a new object is allocated, the heap tracker can indicate that a new object was created. A tagging mechanism similar to that used for data flow can be used to follow the uninitialized values. If the stack grows, the uninitialized bytes that have been added to the stack can be tagged as uninitialized. If impermissible operations are performed on the uninitialized values, it is indicated as an uninitialized value problem.

Some special scenarios can be accounted for. For example, a value may be written to the low byte of a double word. If the whole double word is read in and manipulated (e.g., incremented), it may appear to be an impermissible operation (e.g., incrementing) on the double word. However, such an operation is deemed permitted as long as the low byte was initialized. However, it would still be prohibited to branch based on comparing to the entire value because that would mean branching based on uninitialized information.

### Example 33

### Exemplary System for Detecting Use of a Dangling Pointer

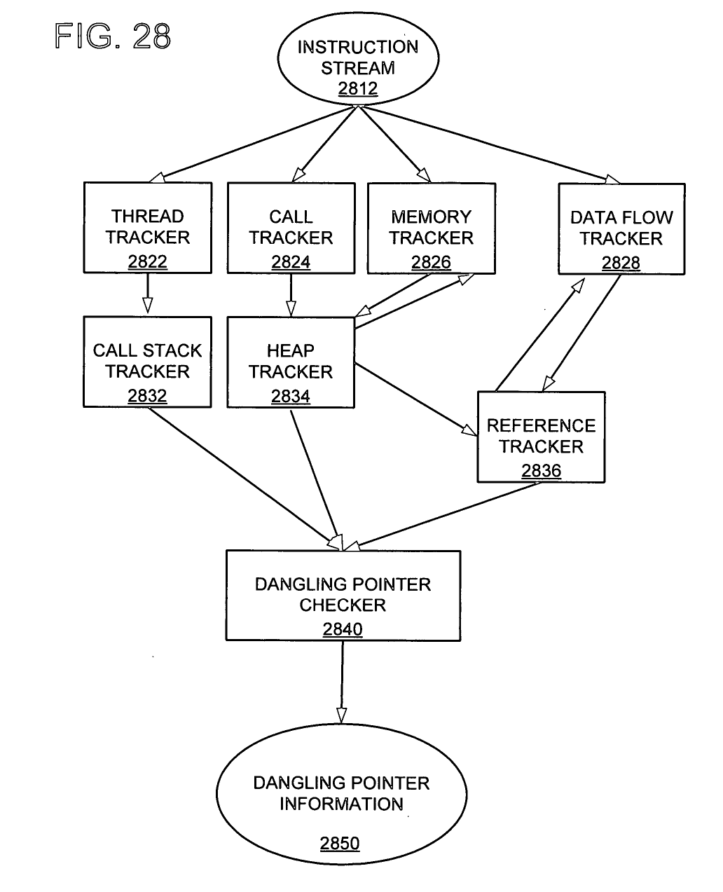

FIG. 28 shows an exemplary system 2800 employing trackers 2822, 2824, 2826, 2828, 2832, 2834, 2836 and a checker 2840 to detect a use of a dangling pointer. The trackers 2822, 2824, 2826, 2828, 2832, 2834, 2836 can be configured similarly to those for the memory leak system shown in FIG. 22.

In practice, additional checkers can be used, the checkers can be otherwise arranged (e.g., checkers can be combined, checkers can be split, or both), or both.

### Example 34

### Exemplary Method for Detecting a Dangling Pointer

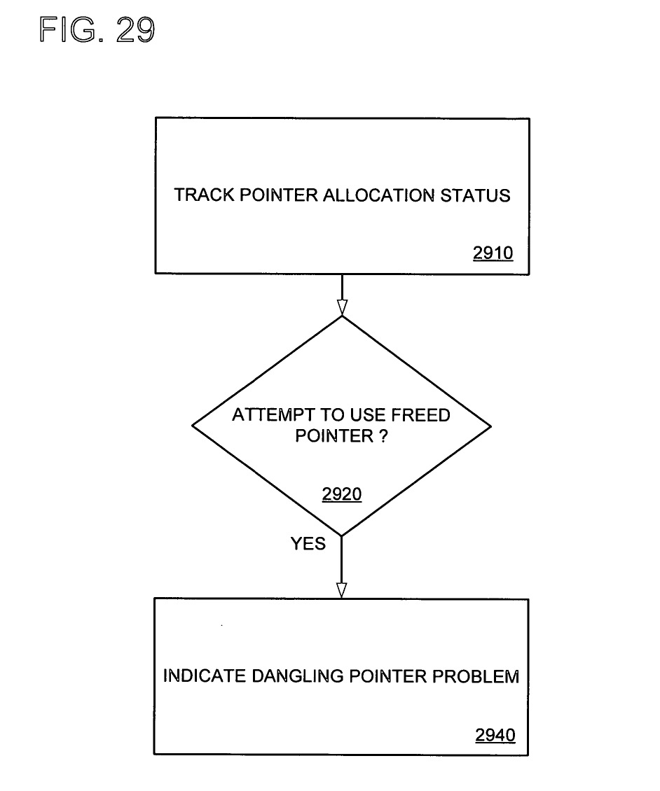

FIG. 29 shows an exemplary method 2900 for detecting use of a dangling pointer (e.g., a pointer to an object that has been deleted or de-allocated). In the example, pointer allocation status is tracked (e.g., via any of the examples described herein). At 2920 it is determined whether an attempt is made to use a pointer to a freed (e.g., deleted or de-allocated) object. If the condition is met, at 2940, a dangling pointer problem is indicated.

### Example 35

### Exemplary System Call Tracker

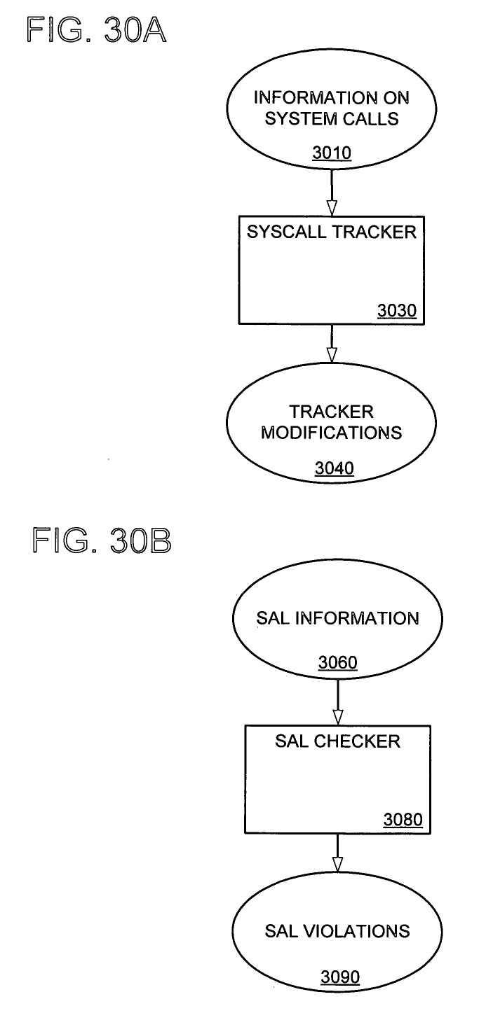

FIG. 30A shows an exemplary system 3000 including a syscall tracker 3030. Such a tracker can recognize when a function call to the operating system is made. Analyzing such information 3010, the tracker 3030 can provide appropriate tracker modifications 3040. In any of the examples described herein, direct analysis of the execution can be limited to user mode (e.g., non-kernel) execution; however, kernel mode execution can be accounted for via the syscall tracker 3030.

By analyzing operating system function calls, it is possible to approximate the behavior of the calls to appropriately modify various trackers. In this way, the syscall tracker 3030 can provide a model of the operating system. In some cases, a system call may be of such unpredictable nature that the entire system is reset (e.g., information up until the time of the call is deemed unreliable and discarded) responsive to detection of such a call.

An example of an operating system function call that can be successfully modeled is a call to fill a buffer with information. If the buffer has a pointer to an object that was being tracked, the pointer is overwritten. So, the appropriate trackers can be instructed to cease tracking the pointer and indicate that it is no longer available.

### Example 36

### Exemplary Annotation Language Checker

FIG. 30B shows an exemplary checker 3080 for determining whether an annotation language has been violated. An exemplary annotation language includes the Source Annotation Language (SAL). For example, an API can include annotations indicating which values are legal (e.g., to avoid buffer overruns) and the like. The checker 3080 can accept annotation information 3060 and indicate any violations detected 3090. The checker 3080 can watch the executed instruction stream, work with a call checker, and the like to achieve effective monitoring.

Source Annotation Language techniques can also be used when developing the syscall tracker of FIG. 30A. For example, operating system APIs may be annotated with SAL, so the sizes of buffers and the like can be determined and used to configure the syscall tracker.

### Example 37

### Exemplary Custom Checker

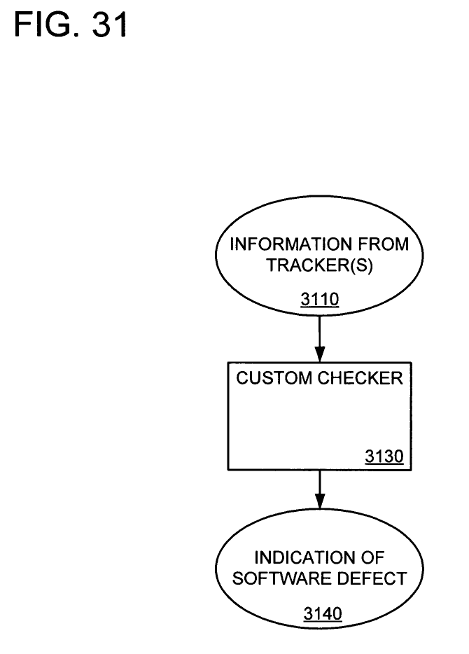

FIG. 31 shows an exemplary system 3100 that includes a custom checker 3130, which receives information 3110 from one or more other trackers and provides an indication of a software defect 3140. The architecture of the analysis tool can accommodate addition of new (e.g., pluggable) checkers that are developed by other parties or developed after the original software is deployed.

### Example 38

### Exemplary User Interface Showing Pointer History

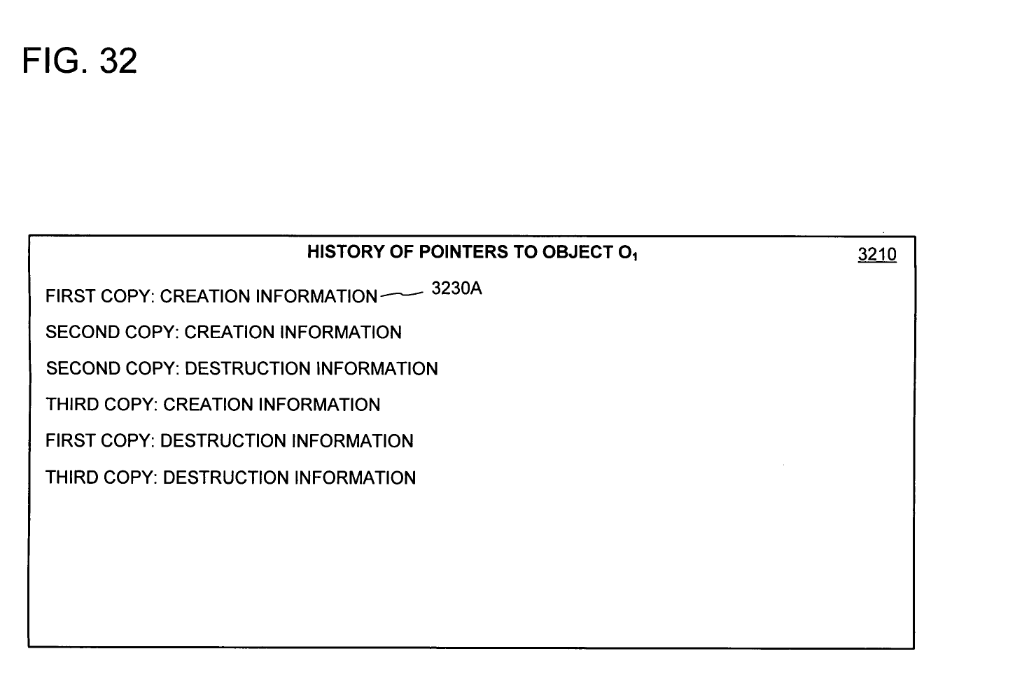

FIG. 32 is a block diagram 3200 of an exemplary user interface 3210 for presenting a history of pointers to an object. In the example, three copies of the pointer have been made. The user interface 3210 can present a history showing creation and destruction information for copies of the pointer to the object.

In the example, three copies (e.g., an original copy and two copies of the original copy) of the pointer were in existence. The first (e.g., from an allocation for the object) is shown in the copy information line 3230A. The history can include a plurality of such copy information lines: one for the creation of the copy and one for the destruction of the copy.

The copy information line 3230A can include an identifier for the copy (e.g., “First,” “1,” “A,” or the like), whether the line represents a creation or destruction, and creation or destruction information, as appropriate. Typically, the lines are ordered by the time in which they occurred. A software developer can thus glance at the user interface 3210 and see the history of the pointer. For example, in the case of a memory leak, a developer can investigate why the memory was not deallocated (e.g., before the third copy was destroyed).

Creation and destruction information can include where the copy resides (e.g., which register, on the stack, or the like) when it is created or destroyed, a location within compiled (e.g., native) code where the creation or destruction takes place, and a location (e.g., source file, line number, or both) within source code where the creation or destruction takes place.

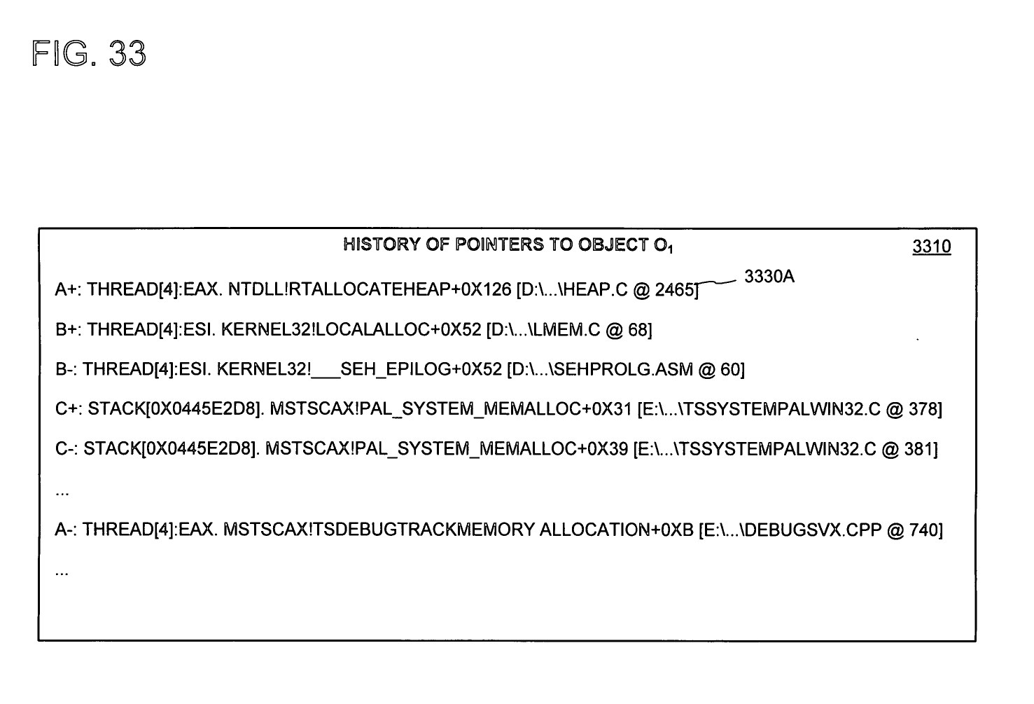

FIG. 33 shows a screen shot 3300 of a user interface 3310 for presenting a history of pointers to an object. In the example, three copies are shown, but in practice there can be more or fewer copies depicted. The copy information line 3330A includes a copy identifier (e.g., A) and an indication of whether the line represents a creation (e.g., “+”) or a destruction (e.g., “−”). Also included is where the copy resides (e.g., in a register, on the stack, or the like) when it was created or destroyed, a location in compiled (e.g., native) code where the creation or destruction takes place, and a location (e.g., source file and line number) in source code where the creation or destruction takes place.

### Example 39

### Exemplary User Interface Showing Pointer History

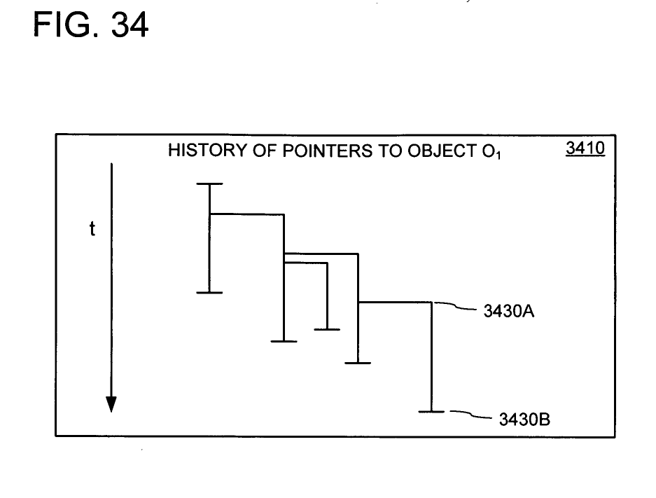

In any of the examples herein, a graphical depiction of pointer history can be used. FIG. 34 is a screenshot 3400 of an exemplary user interface 3410 for presenting a graphical history of pointers to an object. In the example, the t axis represents time. The vertical bars in the history represent the lifetimes of pointers to a same object. So, in the example, over the execution of the program, there were 5 copies of the pointer to the object. Horizontal bars represent duplication (e.g., copying of the pointer) to another location. If for example, the object O₁ had not been deallocated at the end, a memory leak would be indicated because there are no remaining references to the object. Having a graphical depiction of the pointer history can be helpful when debugging to determine the location, source, and nature of the bug.

In terms of the textual pointer histories described above, the top and bottom of the vertical line segments (e.g., intersections of the lines) represent a creation and destruction, respectively of the pointer copy. So, for example, 3430A represents the creation of the last copy of the pointer, and 3430B represents the destruction of the last copy of the pointer.

Information for generating any of the exemplary user interfaces for presenting a pointer history (e.g., the interface 3410) can be stored as XML. The information can then be loaded by a debugger and presented during a debugging session.

### Example 40

### Exemplary Method of Showing Pointer History

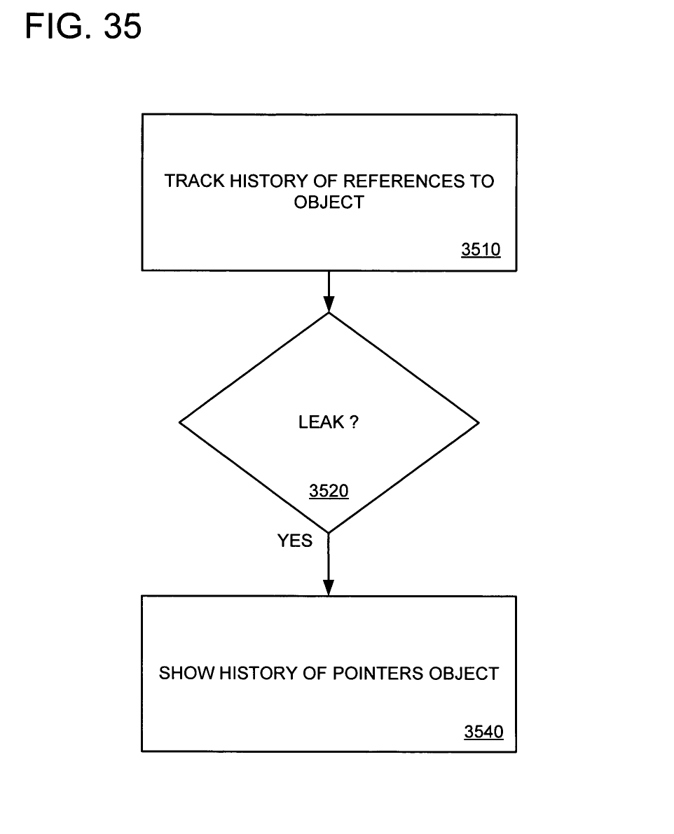

FIG. 35 is a flowchart of an exemplary method 3500 of presenting a history of pointers to an object. At 3510, the history of references to an object is tracked (e.g., for a plurality of objects). At 3520, it is determined whether there is a software defect (e.g., a leak). If so, at 3540, a depiction of the history of pointers to the object is shown at 3540. Such a depiction can be the textual or graphical depictions described herein.

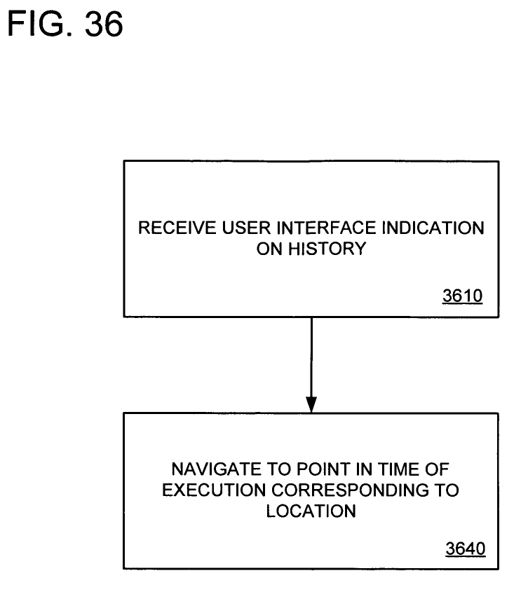

The displayed history can be made interactive to further assist in debugging. FIG. 36 shows an exemplary method 3600 of navigating in a debugger via the depiction of a history of pointers to an object. At 3610, a user interface indication (e.g., click) on a depiction of the history is received. For example, in the case of a textual history, the line can be selected. In the case of a graphical history, one of the creation or destruction points (e.g., an intersection of lines) can be indicated by a user.

At 3640, responsive to the indication, a debugger navigates to a point in time of the execution of the program corresponding to the location. In addition, the call stack at the point in time can be shown to help the developer in debugging. The user can then navigate within the debugger (e.g., via single stepping or the like).

The history depiction can also be adapted for use in an uninitialized value scenario. For example, there is a point in time when the object is allocated and a place where the memory is impermissibly used. As the pointer to the object is copied in the system (e.g., into registers, etc.), it can be followed.

### Example 41

### Exemplary Data Structure for Storing Instruction

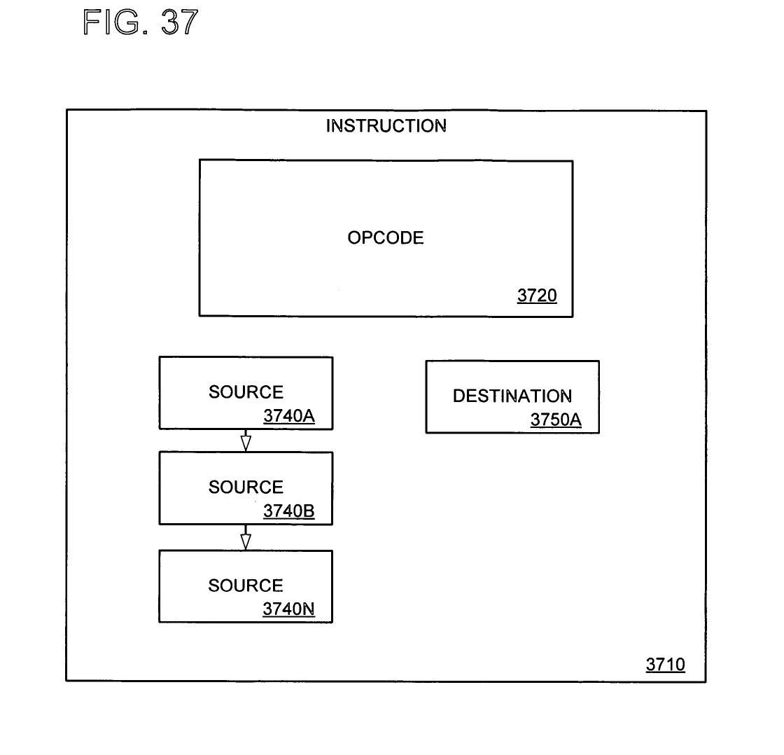

FIG. 37 is a block diagram 3700 of an exemplary data structure 3710 for storing information related to an executed instruction of a program under test and can be used in any of the examples herein to represent an executed instruction and communicate information about an executed instruction. For example, a disassembler can determine some of the information for communication to trackers if desired.

In the example, the instruction data structure 3710 includes an opcode 3720, and a list of zero or more sources 3740A-N and a list of zero or more destinations 3750A, which can be operands for the opcode. Other information (e.g., the size of the instruction, the address, and the like) can also be provided. In practice, a different arrangement can be used.

A pointer to the native executed instruction can be provided so that the low level information (e.g., bytes) of the instruction can be extracted if desired.

### Example 42

### Exemplary Method of Analyzing a Program under Test

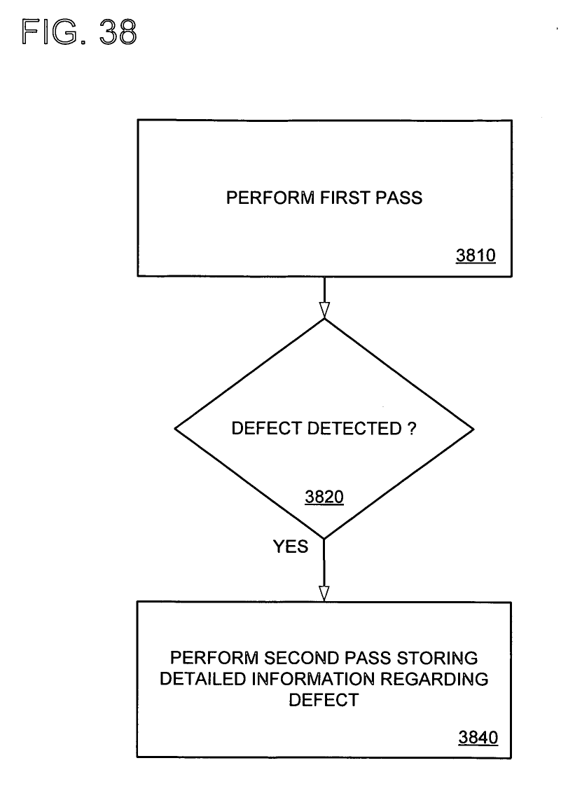

FIG. 38 is a flowchart of an exemplary method 3800 for performing an analysis of an execution of a program via two passes and can be used in any of the examples described herein. At 3810, a first pass is performed. For example, a first pass through a recorded execution of the program can be done in search of defects in the program. Certain detailed information need not be stored during the first pass.

At 3820, it is determined whether a defect was detected (e.g., as a result of the first pass). If so, a second pass is performed storing detailed information regarding the defect at 3840. For example, during the first pass, a particular object may be identified as being a problem. If so, the call stack for the object can be stored (e.g., whenever the object is created) during the second pass.

### Example 43

### Exemplary Defect Distinguisher Strings

In any of the examples described herein, a distinguisher string can be used to identify a detected defect. Such strings can be useful for differentiating among software defects. Also, similar defects can be grouped by using an identical distinguisher string. The string can be set to identify the root cause of the software defect (e.g., the function that initiated the software defect).

In practice, the distinguisher string can attribute the software defect to a function. For example, the defect can be labeled with a distinguisher string based on a function that initiated an operation (e.g., a memory allocation) related to the defect. Because standard functions (e.g., system allocation functions) are assumed to be bug free, the string can be set to the last non-standard function in a chain of calls.

So, for example, in the case of a memory allocation (e.g., related to a memory leak or other pointer problem), the string can be set to the function that initiated a series of calls to standard allocating functions. So, if a call is made by FunctionA( ) to FunctionB( ), which then calls heapalloc( ), which then calls malloc( ), the string can be set to “FunctionB.”

The string can be set to any value that is useful for distinguishing among the software defects (e.g., without becoming so detailed as to uniquely identify every occurrence, even if it has the same cause). The string can be used whenever it is useful to distinguish between defects (e.g., when correlating information for defects, providing a list of bugs to a user in a report, or the like).

### Example 44

### Exemplary Application Programming Interfaces

In any of the examples described herein, functionality can be provided via Application Programming Interfaces (APIs). So, for example, any of the trackers or checkers can provide information about their internal models via an API. Also, the execution analysis tool can be driven by an API and provide its results via an API. In any of the examples herein, events from different trackers (e.g., all trackers) can be handled via a single API.

### Example 45

### Exemplary Advantages

The described techniques can have various advantages. For example, compared to static analysis techniques, detecting a software defect based on an actual execution of the program means that the defect was witnessed during an actual possible execution path, rather than a theoretical path that may never be encountered.

Further, the types of defects that can be detected (e.g., memory leaks, dangling pointers, uninitialized values) are often very difficult to discover during testing. Therefore, potentially serious programming flaws can be detected that could otherwise evade extensive testing.

The techniques can be used to implement computer-assisted debugging. For example, information from the techniques can be provided in a debugger environment to help track down and debug bugs.

### Example 46

### Exemplary Computing Environment

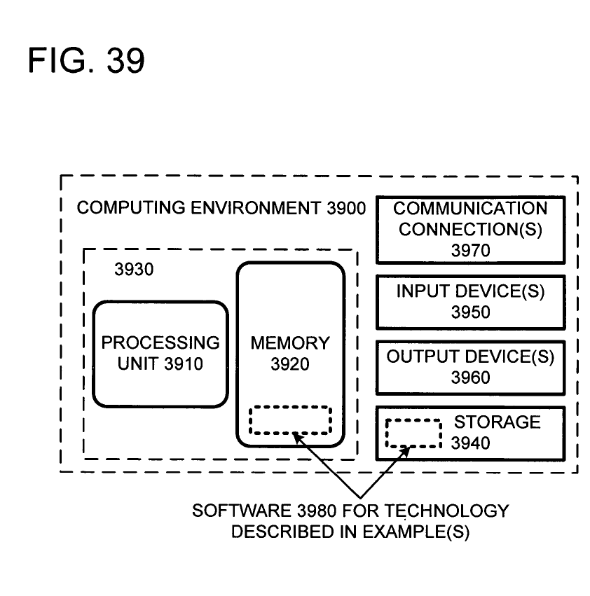

FIG. 39 illustrates a generalized example of a suitable computing environment 3900 in which the described techniques can be implemented. The computing environment 3900 is not intended to suggest any limitation as to scope of use or functionality, as the technologies may be implemented in diverse general-purpose or special-purpose computing environments.

With reference to FIG. 39, the computing environment 3900 includes at least one processing unit 3910 and memory 3920. In FIG. 39, this most basic configuration 3930 is included within a dashed line. The processing unit 3910 executes computer-executable instructions and may be a real or a virtual processor. In a multi-processing system, multiple processing units execute computer-executable instructions to increase processing power. The memory 3920 may be volatile memory (e.g., registers, cache, RAM), non-volatile memory (e.g., ROM, EEPROM, flash memory, etc.), or some combination of the two. The memory 3920 can store software 3980 implementing any of the technologies described herein.

A computing environment may have additional features. For example, the computing environment 3900 includes storage 3940, one or more input devices 3950, one or more output devices 3960, and one or more communication connections 3970. An interconnection mechanism (not shown) such as a bus, controller, or network interconnects the components of the computing environment 3900. Typically, operating system software (not shown) provides an operating environment for other software executing in the computing environment 3900, and coordinates activities of the components of the computing environment 3900.

The storage 3940 may be removable or non-removable, and includes magnetic disks, magnetic tapes or cassettes, CD-ROMs, CD-RWs, DVDs, or any other computer-readable media which can be used to store information and which can be accessed within the computing environment 3900. The storage 3940 can store software 3980 containing instructions for any of the technologies described herein.

The input device(s) 3950 may be a touch input device such as a keyboard, mouse, pen, or trackball, a voice input device, a scanning device, or another device that provides input to the computing environment 3900. For audio, the input device(s) 3950 may be a sound card or similar device that accepts audio input in analog or digital form, or a CD-ROM reader that provides audio samples to the computing environment. The output device(s) 3960 may be a display, printer, speaker, CD-writer, or another device that provides output from the computing environment 3900.

The communication connection(s) 3970 enable communication over a communication medium to another computing entity. The communication medium conveys information such as computer-executable instructions, audio/video or other media information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Communication media can embody computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. Communication media include wired media such as a wired network or direct-wired connection, and wireless media such as acoustic, RF, infrared and other wireless media. Combinations of any of the above can also be included within the scope of computer readable media.

The techniques herein can be described in the general context of computer-executable instructions, such as those included in program modules, being executed in a computing environment on a target real or virtual processor. Generally, program modules include routines, programs, libraries, objects, classes, components, data structures, etc., that perform particular tasks or implement particular abstract data types. The functionality of the program modules may be combined or split between program modules as desired in various embodiments. Computer-executable instructions for program modules may be executed within a local or distributed computing environment.

### Methods in Computer-Executable Media

Any of the methods described herein can be implemented by computer-executable instructions in one or more computer-readable media (e.g., computer-readable storage media).

### Example 47

### Exemplary System for Recording Program Execution

The following describes an exemplary system for recording program execution that can be used in combination with the technologies described herein.

### Example 48

### Exemplary System Employing a Combination of the Technologies

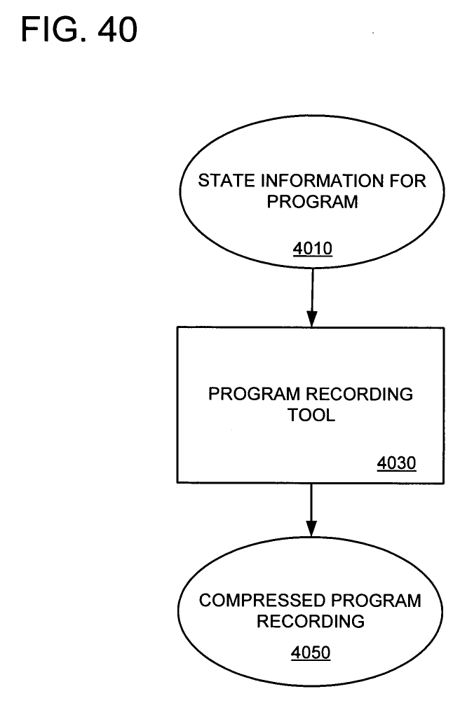

FIG. 40 is a block diagram of an exemplary system 4000 employing a combination of the recording technologies described herein. Such a system 4000 can be provided separately or as part of a software development environment.

In the example, a program recording tool 4030 processes state information 4010 within a software program under test during monitored execution of the program. Such execution can be simulated execution of the program (e.g., by a software simulation engine that accepts an executable version of the program). The program recording tool 4030 can generate a recording 4050 of the execution of the program, which as explained in the examples herein can be compressed. As explained herein, the recording 4050 can include instructions (e.g., code) for the software program under test as well as a series of values that can be consulted to determine values for memory address read operations during playback.

Execution monitoring can monitor state information including read and write operations. For example, the address and size of reads or writes can be monitored.

In practice, the program recording can then be played back to determine the state of the program at various points in time during the monitored execution.

### Example 49

### Exemplary State Information

In any of the examples herein, state information can include state changes or other information about the processor state, changes to or values of memory addresses, or any other changes in the state of the machine (e.g., virtual machine) caused during execution of the program (e.g., by the program itself or services invoked by the program).

For example, a register within a processor can change and values for memory locations can change, information about the value of registers or memory locations can be monitored, or both.

### Example 50

### Exemplary Method Employing a Combination of the Technologies

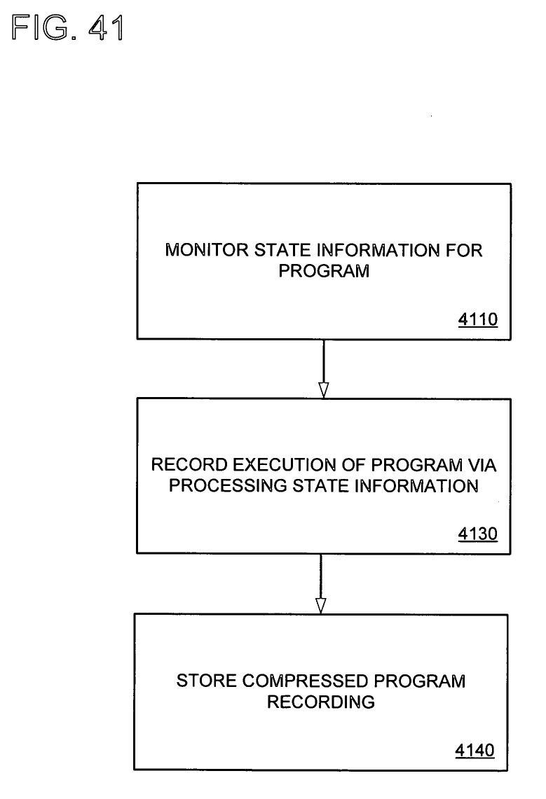

FIG. 41 is a flowchart of an exemplary method 4100 employing a combination of the recording technologies described herein and can be implemented in a system such as that shown in FIG. 40. In the example, at 4110 state information for the program under test is monitored (e.g., by the program recording tool 4010 of FIG. 40). At 4130, the state information is processed to record execution of the program. As described herein, various techniques can be used to reduce the amount of data to be stored when recording execution, resulting in compression.

At 4140, a compressed version of the program's recorded execution is stored.

### Example 51

### Exemplary Program Recordings

A recording of a program's execution (or a “program recording”) can include information about state during recorded monitored execution of the program. In practice, the recording can also include executable instructions of the program, which can be used during playback to simulate execution. In some cases, playback of such instructions can be used to determine state changes without having to explicitly store the state (e.g., without having to store a changed value of a register or memory address when the value changes).

For example, if an instruction merely makes a change internal to the processor, the change can be determined by simulating execution of the instruction, without having to store the resulting value. In practice, such instructions include those that increment registers, add constants, and the like. Compression can be achieved by not including state information in the program recording for such instructions.

### Example 52

### Exemplary System Generating Information about Machine State via Compressed Program Recording

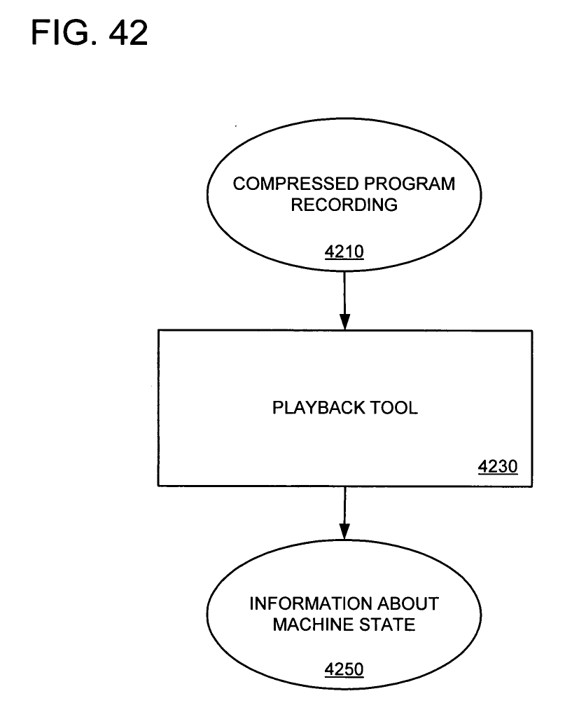

FIG. 42 is a block diagram of a system 4200 generating information 4250 about machine state via a compressed recording 4210 of a program's execution. In the example, a playback tool 4230 accepts the compressed recording 4210 (e.g., such as the compressed recording 4050 of FIG. 40) and generates information 4250 about the machine state.

The information 4250 can include the value of a memory address at a particular point in time during the recorded execution of the program (e.g., what is the value of memory location x after execution of the nth instruction—or after n processor cycles).

In practice, the playback tool 4230 can be used as a debugger tool that a software developer can employ to determine the values of memory addresses and registers during execution of the program.

As described herein, certain information about machine state can be predicted via the playback tool 4230; therefore, the number of values stored in the recording 4210 can be significantly reduced. Because the compressed program recording 4210 can be of a smaller size than an uncompressed trace of the program's execution, the system 4200 can be used to analyze and debug complex programs or programs that run for extended periods of time that could not be efficiently analyzed via an uncompressed trace.

### Example 53

### Exemplary Method of Generating Information about Machine State via Playback

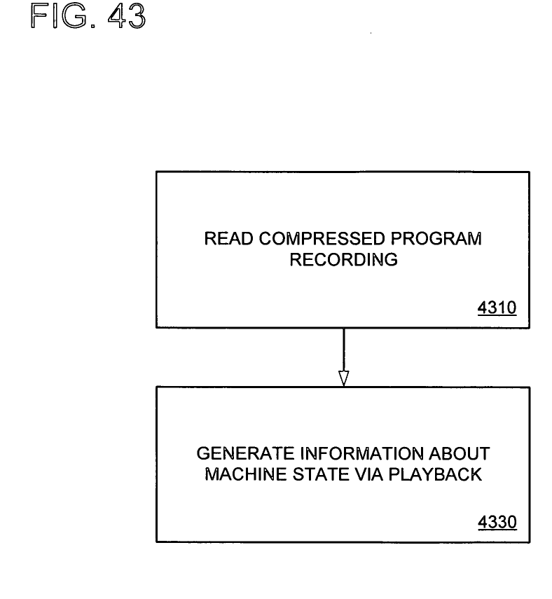

FIG. 43 is a flowchart of an exemplary method 4300 of generating information about machine state via playback of a compressed recording (e.g., such as the compressed recording 4210 of FIG. 42). At 4310, the compressed recording is read. At 4330, information about the machine's state is generated via the playback. For example, the value of registers and memory addresses can be determined for various points of time during execution of the program, according to the state information monitored during recording.

### Example 54

### Exemplary Compression Techniques

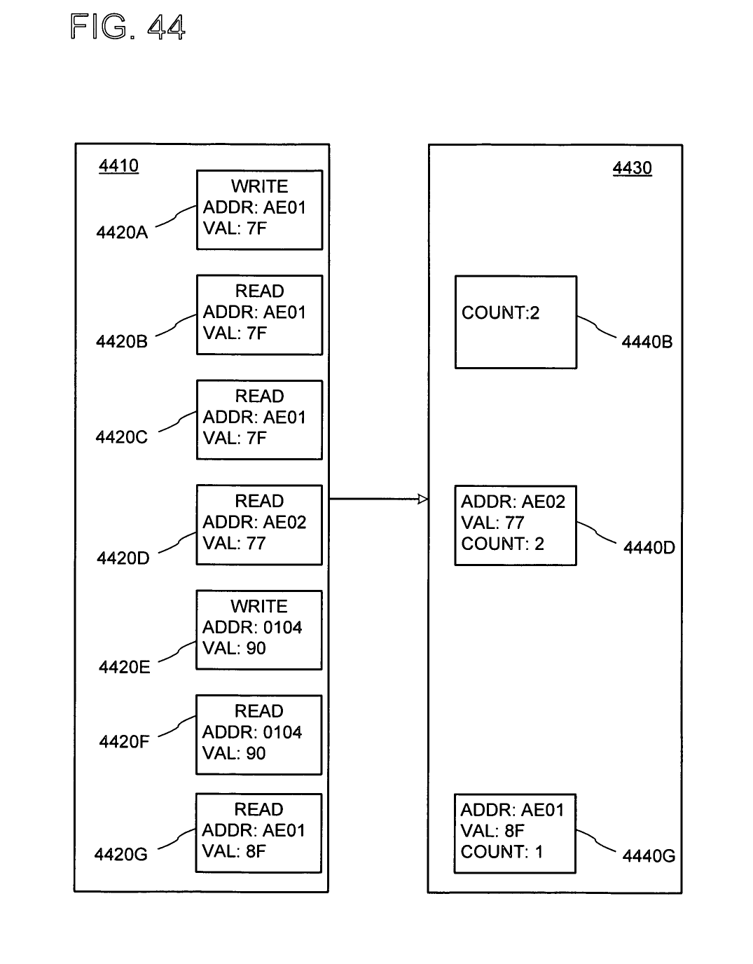

In any of the examples described herein, a variety of compression techniques can be used to reduce the size of a program recording. FIG. 44 shows an example 4400 of a compression technique for use in program recordings.

In the example, activity by a processor executing a program under test is shown in the uncompressed series 4410 of operations 4420A-4420G. The resulting compressed series 4430 of recorded states 4440B, 4440D, 4440F, and 4440G are sufficient to reconstruct the uncompressed series 4410. To conserve space, a count can be stored instead of storing the values for certain memory addresses.

The techniques shown include discarding values for writes, such as the write 4420A. Such a write can be discarded from the compressed series 4430 because the value can be regenerated via the virtual processor and executable instructions of the program under test. So, for example, the value for the write 4420A is not included in the series 4430 because it can be predicted during playback when the write operation is executed (e.g., by a virtual processor). Instead, a count is stored in 4440B to indicate that the next two reads 4420B and 4420C can be correctly predicted based on the value from the write 4420A.

Due to the count stored in 4440B, the series 4430 also does not need to store values for successive reads, if the reads result in the same value. So, for example, the read for operation 4420C need not be recorded because the read before it, 4420B had the same value. In particular, successive identical reads or reads after writes (e.g., when the value has not changed due to an external operation) can be predicted via any of the predictability techniques described herein. The compressed data in 4430 can also indicate the size of read or write operations. However, in practice, the size need not be stored because it can be re-created during playback.

The series 4430 can be stored as a stream. If desired, different streams can be used for the different components of the data (e.g., a separate stream for values and counts, and the like). The information stored in the compressed program recording can also include data about instructions that break virtualization (e.g., instructions that query the time or machine configuration) for consideration during playback.

In practice, the series 4430 can be stored with executable instructions for the program being recorded as a compressed program recording, from which playback can determine the values of the memory addresses without having to store all the values involved in the read and write operations.

### Example 55

### Exemplary Compression via Predictability

The technique of not storing values can also be described as not storing values if they can be predicted. Such predictions can rely on a virtual processor executing instructions of the software program under test and values already loaded (e.g., at playback time) from the compressed program recording.

When executing instructions of the software program under test, it might be expected that the value (e.g., for a memory address) will be a certain value. For example, it is expected that a value read from a memory address will be the value that was last written to it.

In some cases, such an expectation will be wrong. For example, the program may have switched into an unmonitored mode (e.g., kernel mode), which changed the value of the memory address. Further, if other threads or processors are running, they may change the value of the memory address. In such a case, the subsequently monitored value will not have been correctly anticipated, and it can be included in the program recording (e.g., the compressed series 4430). And further, the value could change yet again, so that the read from the value will be yet a different value.

So, predictability can take advantage of the observation that a value is expected to be what was last written to the memory address, but can also consider which values have already been loaded from the compressed program recording. A value that can be correctly predicted from a write or an entry in the compressed series 530 that has already been loaded (e.g., at playback time) need not be stored again in the program recording. Instead, for example, a running count of the number of times in a row that values will be correctly predicted by the virtual processor and the entries already loaded (e.g., at playback time) from the series can be stored. For cases in which the prediction is correct, a value need not be stored in the program recording (e.g., the compressed series 4430). When the prediction is not correct, the value can be stored so that it can be loaded during playback.

Because the same virtual machine (e.g., or an emulator of it) consulting the stored program recording will predict the same values during playback, storing the predictable values is unnecessary. Avoiding storage of the values can significantly reduce the size of the program recording.

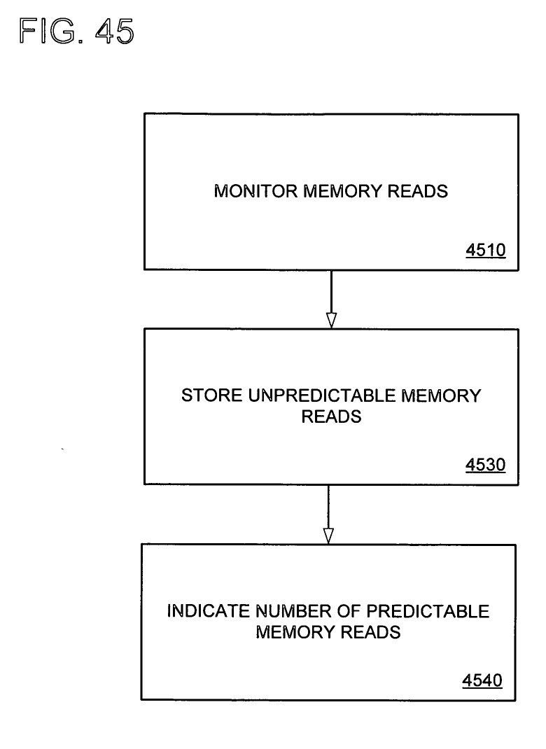

FIG. 45 shows an exemplary method 4500 for compressing a program recording via predictability. At 4500, execution of the program is monitored. For example, reads of memory addresses are monitored. At 4530, unpredictable values for reads of memory addresses are stored as part of the program recording. However, values for memory addresses that are predictable need not be stored. Instead, some other indication can be used. For example, at 4540, a running count of the number of times in a row that values will be correctly predicted during playback can be stored (e.g., as a count). In some cases, such a count indicates the number of successive predictable memory reads. As described herein, values for writes to memory can be discarded (e.g., an indication of the value written need not be included in the program recording for the write operation) because the value for the write operation can be determined during playback via the executable instructions and the virtual processor.

### Example 56

### Exemplary System for Determining Memory State

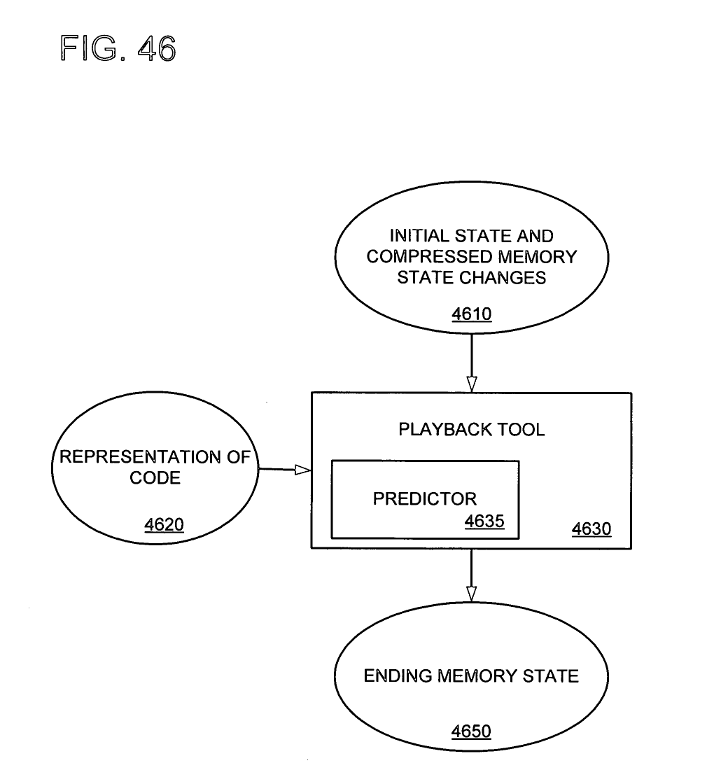

FIG. 46 is a block diagram of an exemplary system 4600 for determining memory state 4650 via recorded compressed memory state changes 4610 and a representation 4620 of executable instructions for a program.

In the example, a playback tool 4630 accepts an initial state and recorded memory state changes 4610 for execution of a program along with a representation 4620 of the executable instructions for the program. Using a predictor 4635 (e.g., which can include a virtual processor that can execute the instructions 4620), the playback tool 4630 can determine an ending memory state 4650 at a particular point during the execution, which will reflect the memory state of the program when execution was monitored and recorded.

### Example 57

### Exemplary Method of Using a Predictor and Compressed Memory State Changes to Determine Memory State

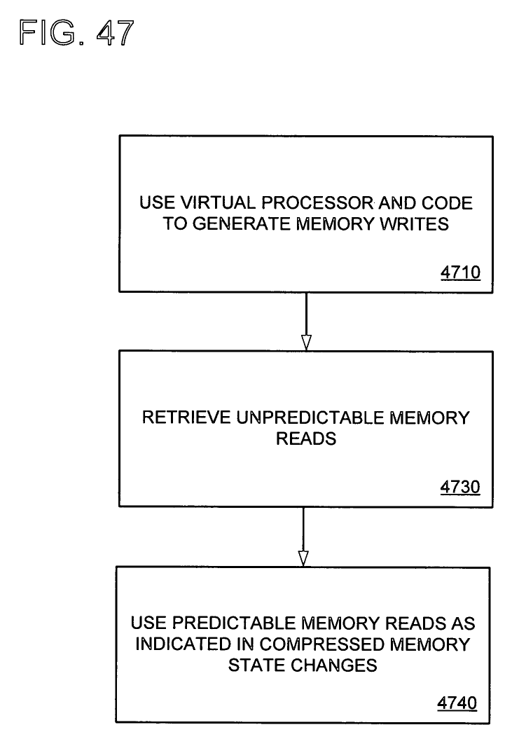

In any of the examples herein, compressed memory state changed can be included in a program recording. FIG. 47 shows an exemplary method 4700 of using a predictor and compressed memory state changes to determine memory state.

At 4710, a virtual processor can be used in conjunction with a representation of executable instructions to generate appropriate values for memory write operations. As a result, values for the memory write operations by the processor need not be stored in the program recording. When determining the value of memory addresses, values for unpredictable memory reads are retrieved from the program recording at 4730.

Predictable memory reads can be predicted via a predictor, and the compressed memory state changes can indicate whether the memory read is predictable or not (e.g., by keeping a count of successive predictable reads). At 4740, the predictable memory reads as indicated in the compressed memory state changes are used to determine the value of memory addresses.

Because the values involved in memory writes and reads can be determined, the value for a particular address in memory can be determined at a specified point in time for the program.

### Example 58

### Exemplary Recording System Employing a Cache to Determine

Predictability of Memory Read Operations

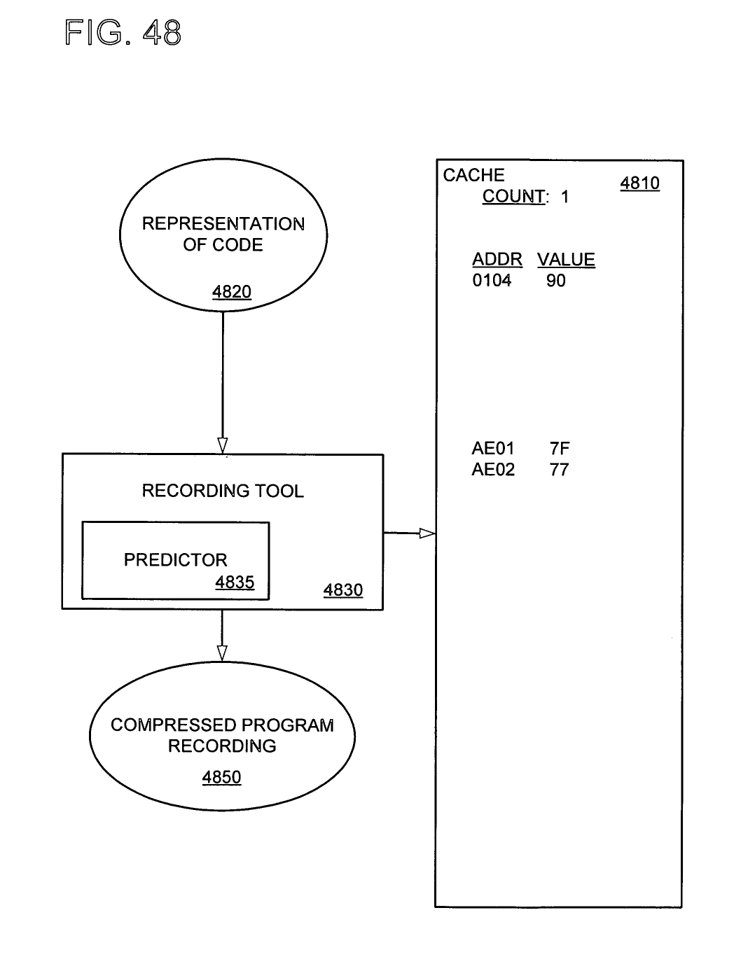

The resulting value of a memory read operation by a processor can often be predicted during playback (e.g., it will remain the same or be written to by the processor) unless it is changed by some mechanism external to that processor or some mechanism that is not monitored during program recording. FIG. 48 shows an exemplary system 4800 employing a cache 4810 to determine predictability of memory read operations. In the example, a representation 4820 of the executable instructions of the program are accepted by a recording tool 4830, that includes a predictor 4835 (e.g., including a virtual processor operable to execute or simulate execution of the instructions in representation 4820). The recording tool 4830 can generate an appropriate compressed program recording via monitoring execution of the instructions 4820.

As shown in the example, rather than storing successive predictable values for read operations, the cache 4810 can include a hit count. If another read operation involves the value for the address already indicated in the cache 4810, the count can simply be incremented. If a different (unpredictable) value is detected, the entry for the memory address can be stored and a new count started for the different value.

The example shows the cache after having recorded the read 4420E of FIG. 44. The count in the cache 4810 is set to 1 because during playback, there is one value that can be predicted (i.e., 77 for memory address AE02) without having to load another value from the compressed series 4430 (e.g., the value will already have been loaded from recorded entry 4440D).

After recording the read 4420F, the count will be increased to 2 because during playback, there will be one more value that can be predicted (i.e., 90 for memory address 0104) without having to load another value from the compressed program recording (e.g., the value will already be known based on the write 4420E).

Thus, for example, a value can be correctly predicted during playback because it has already been loaded from the compressed program recording or because a virtual processor will perform a write operation for the memory address. Recording the execution can include determining which values will be correctly predicted. Values that can be correctly predicted at playback need not be written to the compressed program recording.

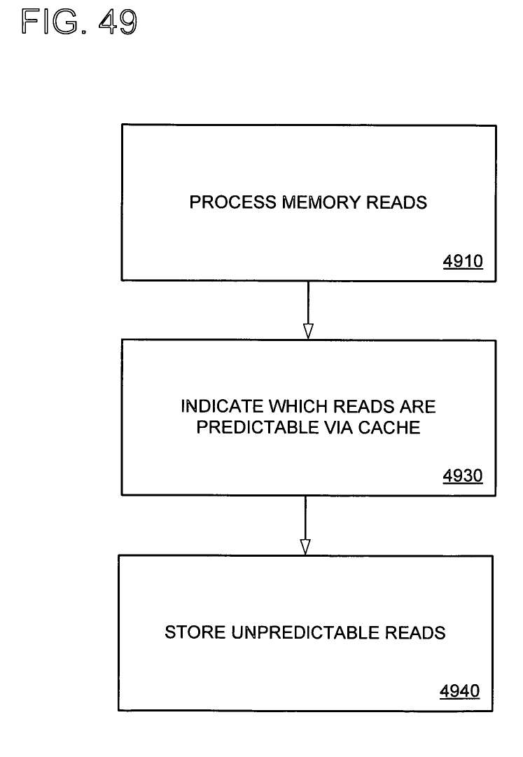

FIG. 49 is a flowchart showing an exemplary method 4900 of employing a cache to determine predictability of memory read operations. At 4910, memory reads during monitored execution are processed. The cache can be checked to see if the memory read will be predictable at playback. If the value is predictable, the cache can be updated to so indicate at 4930. Unpredictable reads can be stored at 4940.

### Example 59

### Exemplary Cache Layout

In any of the examples herein, the cache can take the form of a buffer of fixed size. An index for the cache can be computed using a calculation scheme (e.g., a modulus of the size of the cache) on the address.

The cache can be of any size (e.g., 16 k, 32 k, 64 k, and the like) as desired.

### Example 60

### Exemplary Technique for Managing Cache to Reflect Predictability

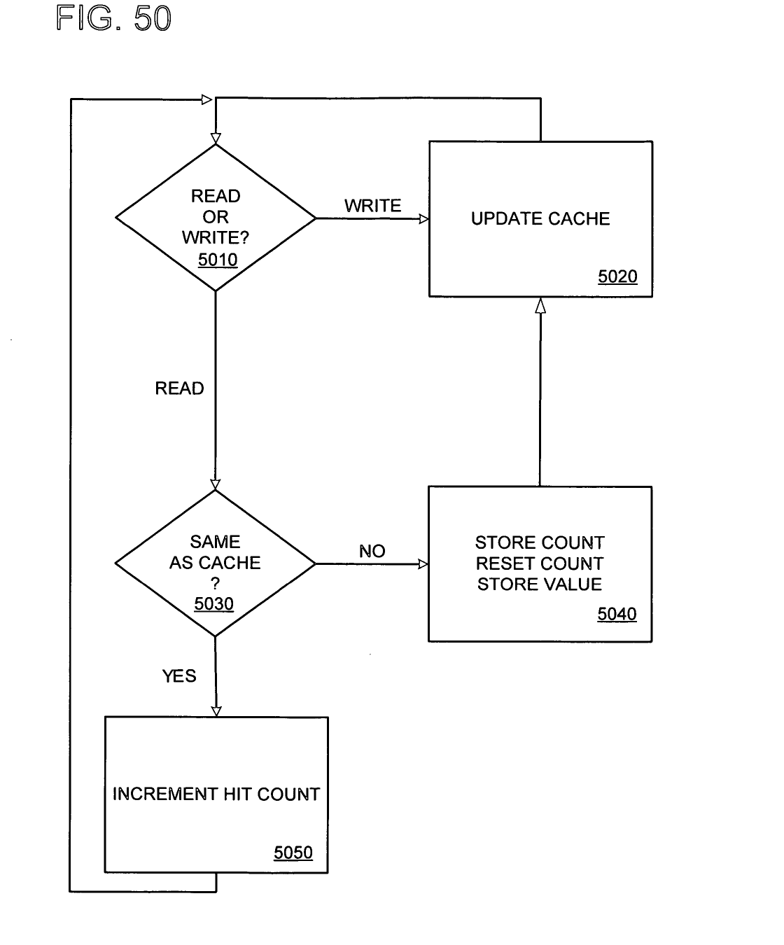

FIG. 50 shows an exemplary method 5000 for managing a cache to reflect predictability. In the example, read and write operations during monitored execution of a program are analyzed to generate a compressed program recording.

At 5010, an operation during monitored execution is analyzed to determine whether it is a read or a write. If the operation is a write, the cache is updated at 5020 (e.g., the value is placed in the cache). As noted elsewhere herein, an indication that the write operation changed the value of memory need not be stored in the compressed program recording because it can be determined via execution of the executable instructions for the program.

If the operation is a read, it is then determined at 5030 whether the value involved in the read is the same as that indicated in the cache (e.g., is it predictable). If so, the hit count for the cache is incremented at 5050, and the analysis continues.

If the value is not predictable, at 5040, the count and value are stored as part of the compressed program recording (e.g., as part of the memory state changes). The count is then reset, and the cache is updated with the new value at 5020. Analysis continues on subsequent reads and writes, if any.

At the conclusion of the method, the information in the cache can be flushed (e.g., to the program recording) so that the remaining information left over in the cache is available during playback.

### Example 61

### Exemplary Playback System Employing a Cache to Take Advantage of Predictability of Memory Read Operations

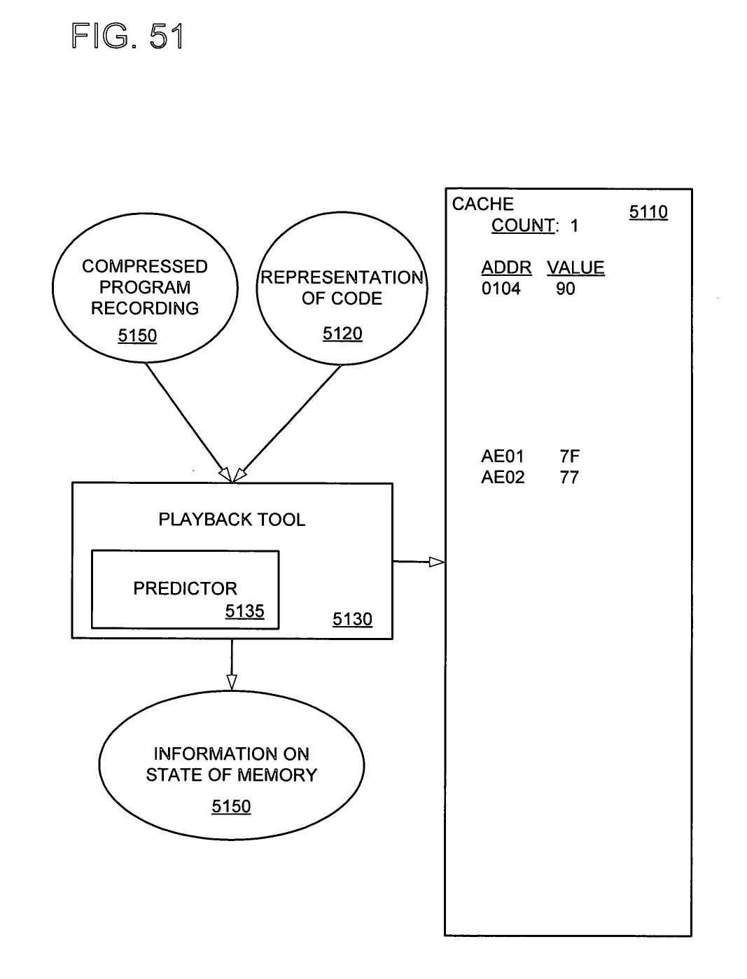

Playback of a compressed program recording can similarly employ a caching technique to correctly determine the value of a memory address. FIG. 51 shows an exemplary system 5100 that employs a cache to take advantage of predictability of memory read operations. Such a system 5100 can be included, for example, in a debugging tool. In the example, a representation 5120 of the executable instructions of the program and a compressed program recording 5150 are accepted by a playback tool 5130, that includes a predictor 5135 (e.g., including a virtual processor operable to execute or simulate execution of the instructions in representation 5120). The playback tool 5130 can generate information (e.g., a value of an address) on the state of memory that reflects what was monitored during recording.

As shown in the example, rather than storing successive predictable values for read operations, the cache 5110 can include a hit count, which is read from the compressed program recording 5150. If a read operation involves an address and the hit count indicates the value is unchanged, the count can simply be decremented. If the count goes down to zero, a different (unpredictable) value is indicated; the entry for the memory address can then be read from the recording 5150 together with a new hit count for the cache.

The cache is thus able to store at least one value of a memory address as a single stored value that can be used plural times (e.g., reused as indicated in the hit counts) during playback to indicate successive identical values for memory read operations for the memory address according to the compressed recording.

FIG. 51 shows the cache 5110 after having played back the entries 4440B and 4440D and the executable instructions related to reads and writes 4420A through 4420E. The hit count in the cache 5110 is 1 because the count loaded from entry 5140D has now been decreased by one due to the read 4420D (the value for which had already been loaded from the entry 4440D. As indicated by the count, there still remains 1 value that can be correctly predicted without having to load another value from the compressed program recording at playback time (i.e., the value 90 for the read 4420F can be correctly predicted due to execution of the executable instructions related to the write 4420E). After the executable instructions related to the read 4420F is executed, the count will be decreased again and reach zero. The next value (i.e., 8F for the address AE01) cannot be correctly predicted at playback time without loading another value from the compressed series 4430. So, during playback, the entry 4440G is consulted to determine the proper value.

The cache can thus store a predictable value for a memory address and a hit count indicating how many successive times the cache will correctly predict values in succession.

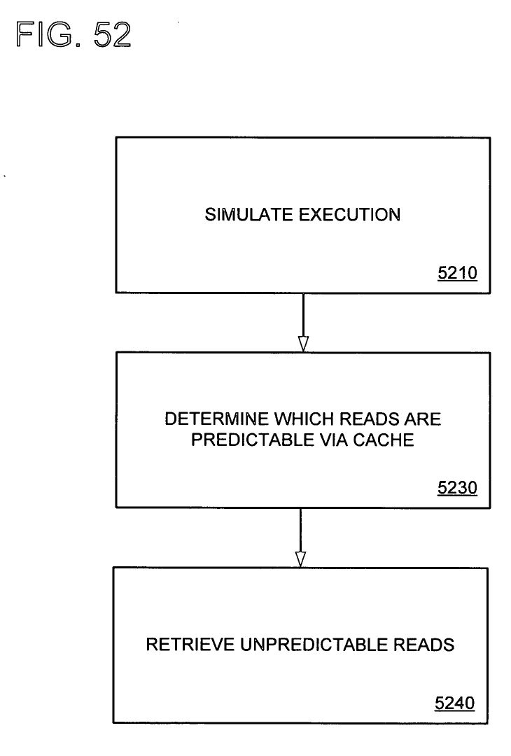

FIG. 52 is a flowchart showing an exemplary method 5200 of employing a cache to determine the value of memory read operations via predictability as indicated in a compressed program recording. At 5210, execution is simulated via representation of executable instructions for the program. Memory reads can be encountered during execution simulation. At 5230, a cache can be used to determine which reads are predictable. Unpredictable reads can be retrieved at 5240.

### Example 62

### Exemplary Technique for Managing Cache to Take Advantage of Predictability

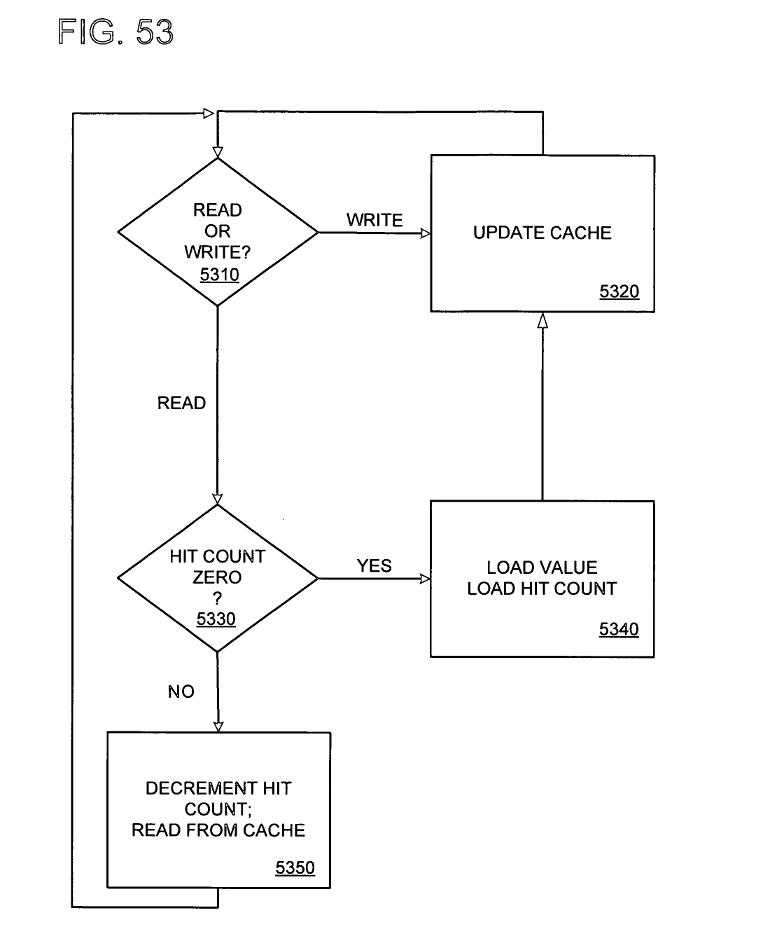

FIG. 53 shows an exemplary method 5300 for managing a cache to take advantage of predictability as indicated in a program recording. In the example, the outcome of read and write operations are determined based on a compressed program recording containing information showing monitored values. Not all monitored values need to be included in the recording because some can be predicted. When the method 5300 is started, initial values from the program recording can be read from or written to the cache to begin. Alternatively, the cache can be reset (e.g., set to zeros) when starting both recording and playback.

At 5310, an operation during playback is analyzed to determine whether it is a read or a write. If the operation is a write, the cache is updated at 5320 (e.g., the value is placed in the cache). The value for the write can be determined via execution of the executable instructions for the program.

If the operation is a read, it is then determined at 5330 whether the hit count in the cache is zero. If not, the hit count is decremented at 5350, and the value for the read is taken from the cache.

If the hit count is zero, then a new value and new hit count are loaded (e.g., from the program recording) at 5340. The new value is used for the value of the read. At 5320 the cache is updated to reflect the new value and hit count.

Processing for further operations, if any, continues at 5310.

### Example 63

### Exemplary Method of Determining a Value for a Memory Address at a Particular Time

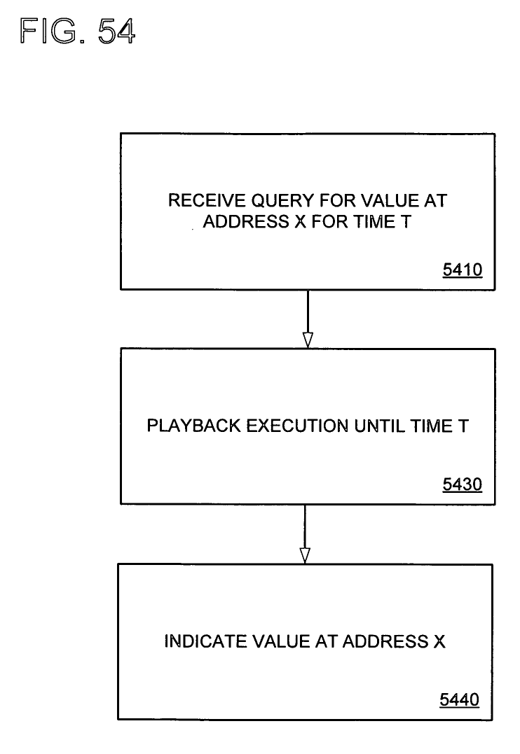

FIG. 54 is a flowchart of an exemplary method 5400 of determining a value for a memory address at a particular time. For example, when debugging a program, a developer may wish to see what the value of a memory address is at a particular point during the program's execution.

At 5410, a query is received for the value of an address x at time t. The time may be expressed absolutely (e.g., after this instruction, after this many clock cycles, etc.) or relatively (after the next n instructions, etc.) or implicitly (e.g., at the current point during execution).

At 5430, a program recording is played back until the time t is reached using any of the techniques described herein. Then, at 5440 the value at the address x is indicated. For example, a debugging tool may show the value on a user interface.

### Example 64

### Exemplary Request for Value Deep within Playback Data

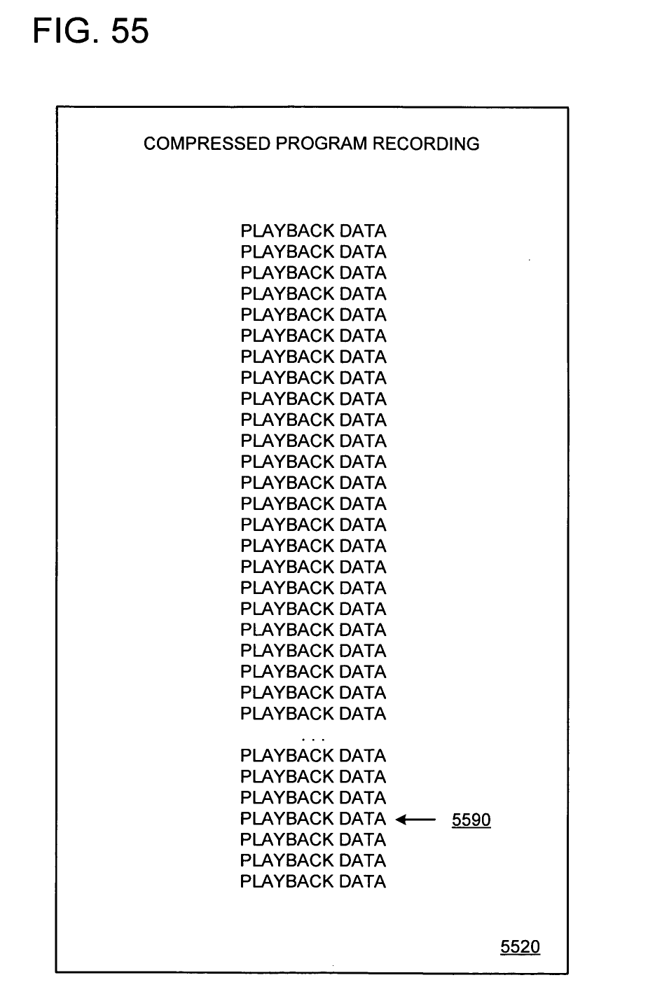

FIG. 55 shows a scenario 5500 involving a request 5590 for a value of a memory location deep within the playback data of a compressed program recording 5520. Although the compressed program technique can reduce the amount of storage space and processing involved during recording and playback, a request 5590 for a value can still come deep within the playback data (e.g., after many processor cycles). The value can be determined via playback of the playback data from the beginning of the recording 5520 to the point in time for which the request 5590 is made.

### Example 65

### Exemplary Key Frames within a Compressed Program Recording

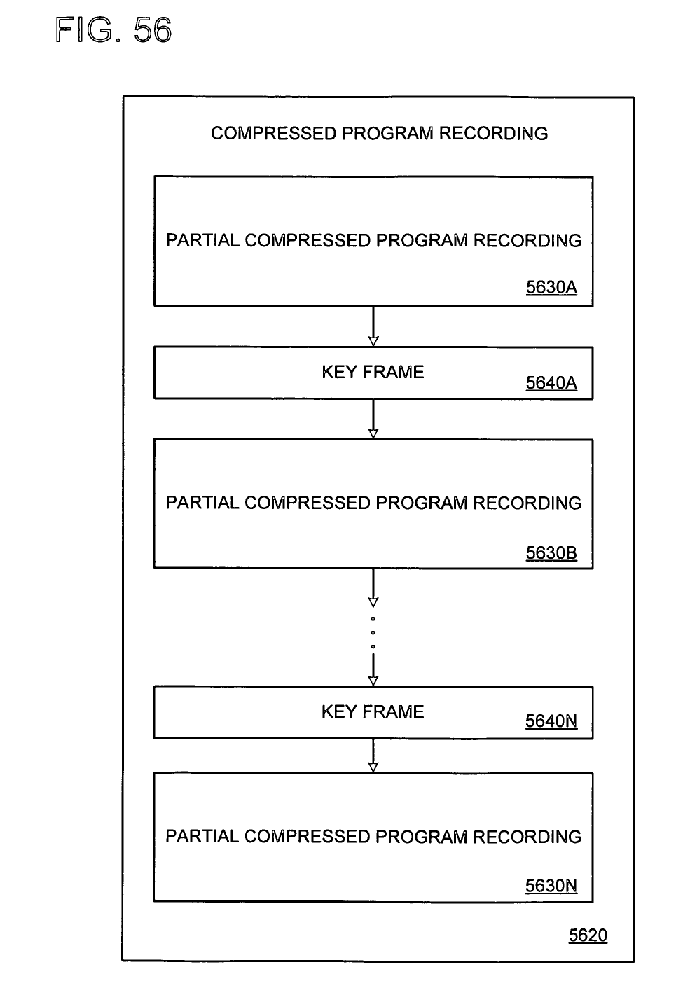

FIG. 56 shows a scenario 5600 involving a request compressed program recording 5620 that includes one or more key frames 5640A-5640N. A key frame can be placed in an intermediary location within the program recording and serve as an alternate starting point, rather than having to start at the beginning of the recording 5620. In this way, random access playback for the compressed program recording can be achieved (e.g., playback can begin at any key frame).

Thus, if playback begins at key frame 5640A, the instructions in the partial compressed program recording 5630A need not be played back. In some cases, such as when determining the value of a memory location that is modified subsequent to the key frame 5640A, the contents of the earlier compressed program recordings (e.g., 5630A) may be immaterial to the result and can be ignored. In this way, the amount of processing performed to determine state can be reduced.

### Example 66

### Exemplary Method of Generating Key Frames

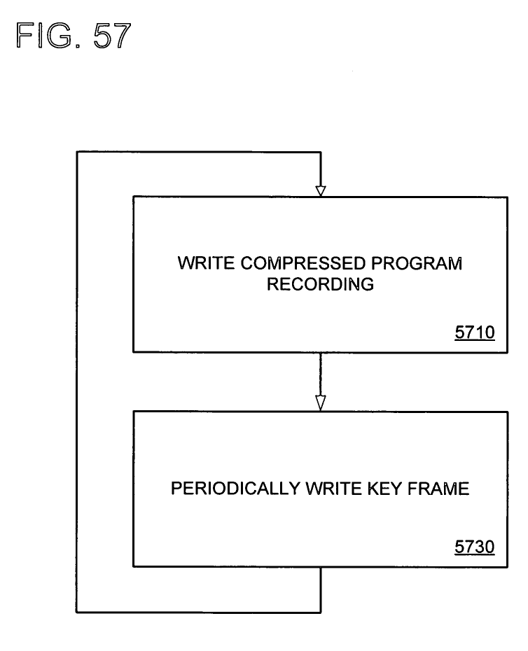

FIG. 57 shows an exemplary method 5700 of generating key frames for use in a compressed program recording. At 5710, any of the techniques described herein for writing a compressed program recording can be employed to write the compressed program recording. At 5730, a key frame is periodically written to the compressed program recording. The key frame can include the processor state at the time the key frame is written to facilitate starting at the location during playback.

In implementations involving a cache, the cache can be flushed or stored before writing the key frame. As a result, operations involving memory locations will update the cache.

The illustrated technique can involve generating key frames while the program is being monitored or at a later time. In some cases, it may be desirable to generate the key frames in response to activity in a debugger (e.g., by generating key frames for areas proximate the current time location being investigated in a debugger by a developer).

The frequency at which key frames are generated can be tuned (e.g., increased or decreased) to optimize performance and compression.

### Example 67

### Exemplary Key Frame

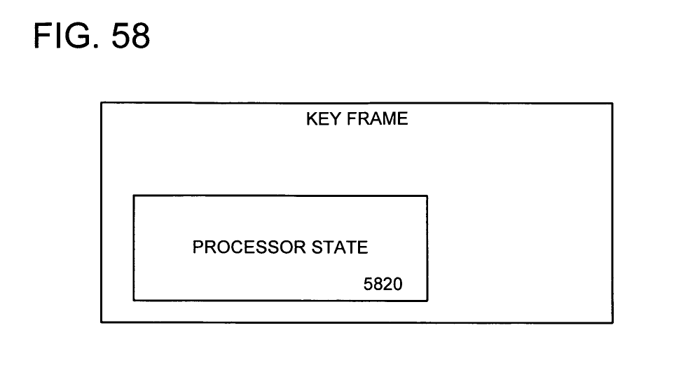

FIG. 58 shows an exemplary key frame 5800. In the example, the key frame 5800 includes the processor state 5820 at a time corresponding to the key frame's temporal location in the compressed program recording. For example, register values can be included in the processor state 5820.

The key frame need to be stored (e.g., if the cache is flushed). Alternatively, the cache could be stored (e.g., if storing results in better compression).

### Example 68

### Exemplary Method of Employing a Key Frame

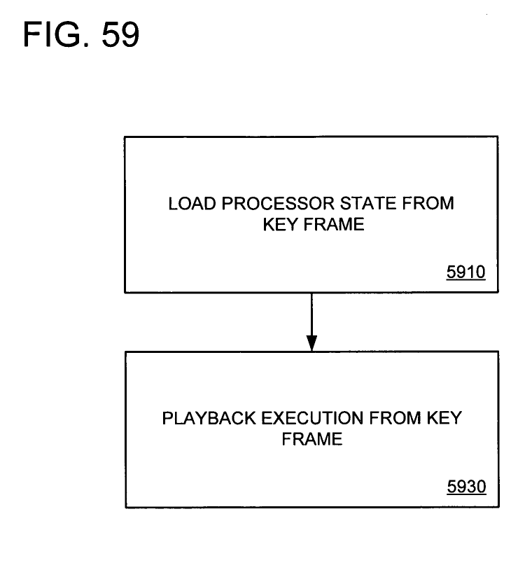

FIG. 59 shows an exemplary method 5900 of employing a key frame. At 5910, processor state is loaded from the key frame. At 5930, execution is played back at points in time after the key frame.

### Example 69

### Exemplary Request for Memory Value Deep within a Program Recording with Key Frames

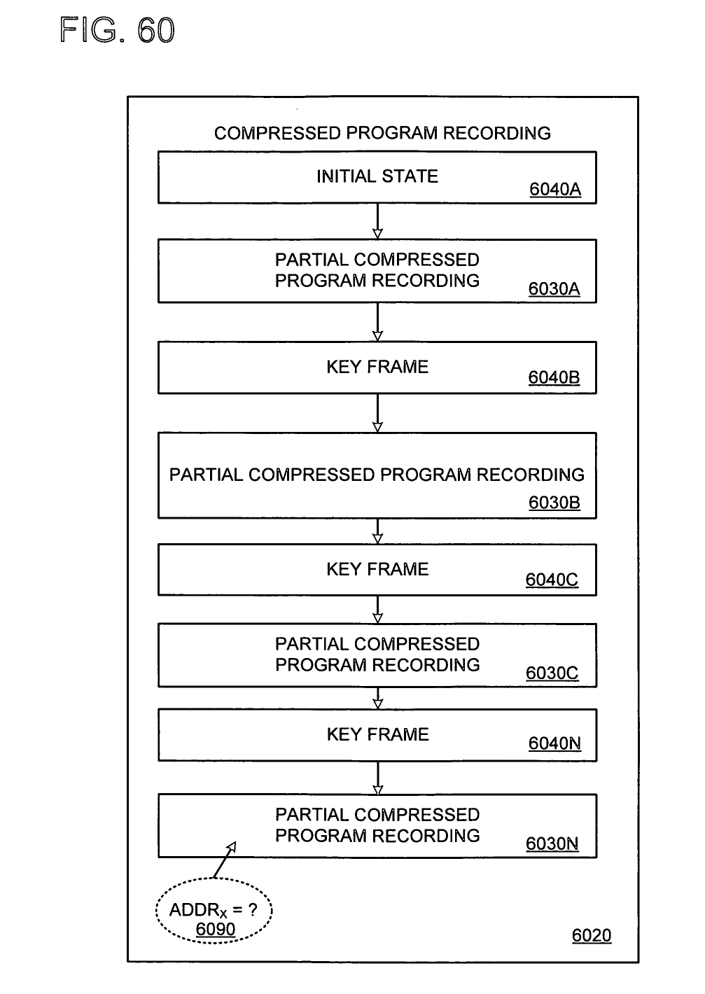

FIG. 60 shows a scenario 6000 involving a request 6090 for a memory value deep within a program recording 6020 with key frames 6040A-6040N and partial compressed program recordings 6030A-6030N.

Although the example can take advantage of the key frames 6040A-6040N, fulfilling the request 6090 may still involve considerable processing. If, for example, playback is initiated at key frame 6040N, and the value for the address x cannot be determined (e.g., does not appear in the partial compressed program recording 6030N), processing can continue to start playback at each of the key frames (e.g., in reverse order or some other order) to see if the value can be determined.

### Example 70

### Exemplary Summarization Index

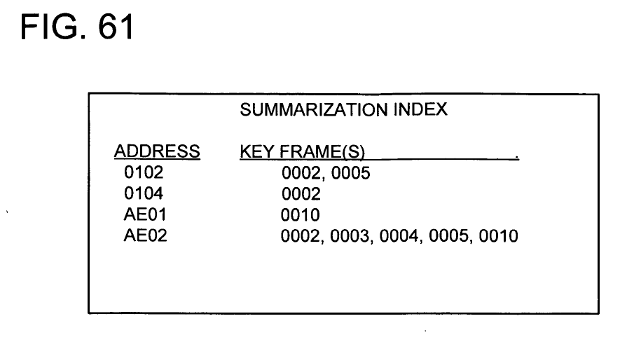

To avoid the searching situation shown in FIG. 60, an index can be used. A summarization index 6100 associating key frames with memory addresses is shown in FIG. 61. When a request for the value of a memory address is received, the index 6100 can be consulted to determine at which key frames playback can be commenced to determine the value. Addresses for which memory values can be determined via playback of partial compressed program recordings immediately following a key frame are associated with the key frame in the index.

If desired, more detailed information about the instructions or the instructions themselves can be stored in the index. For example, a reference to where the instructions following the key frame involving a particular memory address can be found can be stored.

If desired, basic information about key frames (e.g. when the key frame occurred and where it can be found) can also be stored in the summarization index.

### Example 71

### Exemplary Method for Generating Summarization Index and Method for Processing Requests

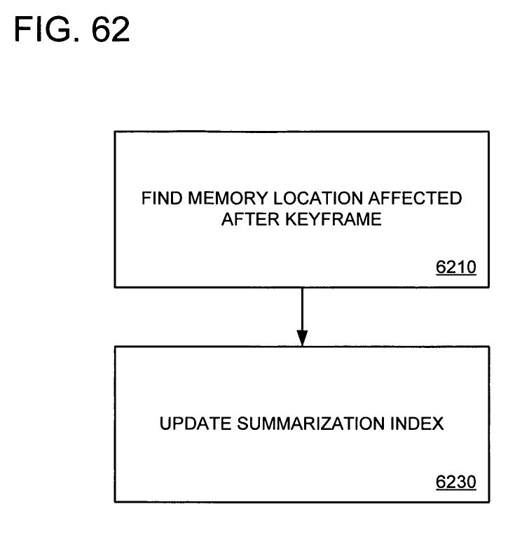

FIG. 62 shows an exemplary method 6200 of generating a summarization index. At 6210, a memory location affected by a partial compressed program recording immediately following key frame is found. At 6230, the summarization index is updated to associate the key frame with the memory location.

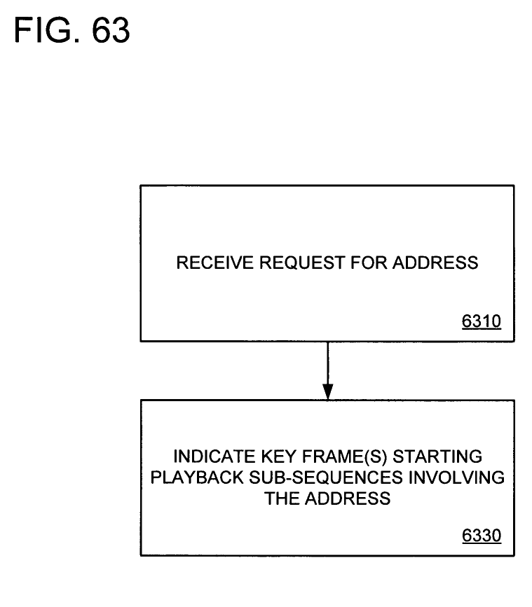

FIG. 63 is a flowchart showing an exemplary method 6300 of processing a request for finding key frames associated with a memory address. At 6310, a request is received to find key frames for a memory address (e.g., as a result of a request to find the value of the memory address at a particular time during execution of a program under test).

Using the index, the key frame(s) are found. At 6330, the one or more key frames starting playback sub-sequences involving the address (e.g., from which the value of the address can be determined, such as those sub-sequences involving reads or writes of the address) are indicated.

In practice, playback can then begin at the key frame closest to and earlier than the time location for which the value of the memory address was requested.

### Example 72

### Exemplary Scenario Involving Change to Memory Address Remote from Time of Request

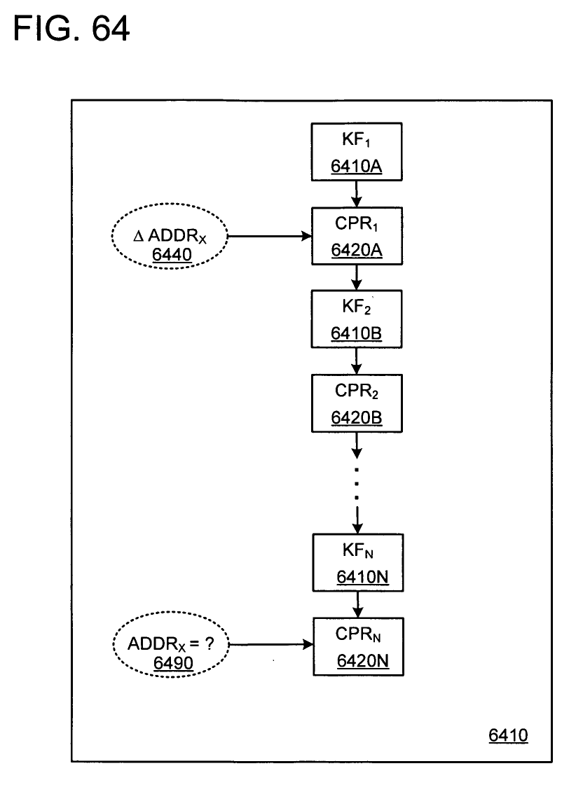

FIG. 64 shows a scenario 6400 involving a change 6440 to a memory address at a time remote from the time 6490 for which the value of the memory address was requested. In the example, a compressed program recording 6410 includes a plurality of key frames 6410A-6410N and partial compressed program recordings 6420A-6420N.

Responsive to receiving the request 6490, a considerable amount of processing may need to be done to determine the value of the address x. Even taking advantage of the key frames may involve executing several of the subsequences 6420A-N to determine within which the memory location appears. And, even with the summarization index, the partial compressed program recording 6420 is consulted. In a program involving a large number of instruction cycles, it may not be efficient to load data for replay to determine activity so remote in time.

### Example 73

### Exemplary Snapshots

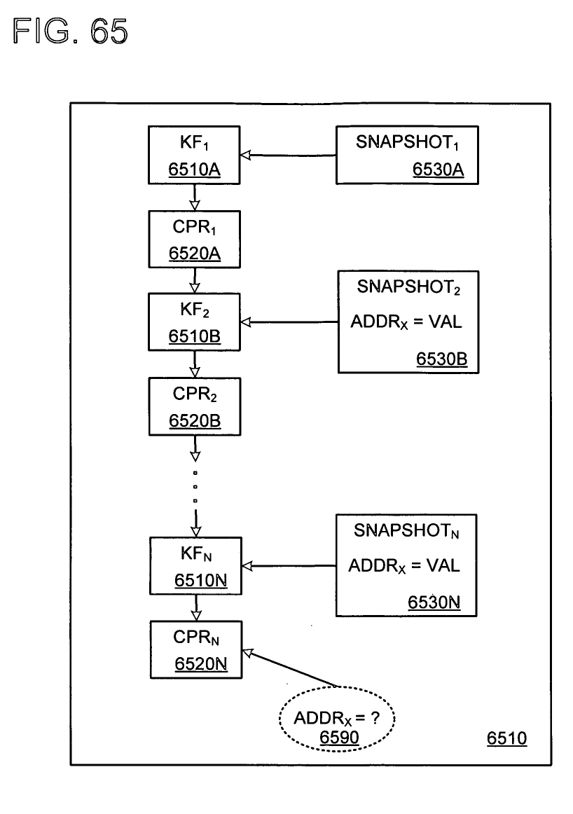

FIG. 65 shows a system 6500 that involves a compressed program recording 6510 storing snapshots of memory locations. In the example, in addition to the key frames 6510A-6510N and the partial compressed program recordings 6520A-6520N, one or more snapshots 6530A-6530N are included in the compressed program recording 6510.

The snapshots 6530A-6530N can include a list of memory addresses and their associated values at the point in time during execution associated with the respective snapshot. Accordingly, a request 6590 for the contents of a memory address x can be fulfilled without having to replay the compressed program recording at which the memory address can be found. Instead, the closest snapshot before the request can be consulted (e.g., snapshot 6530N).

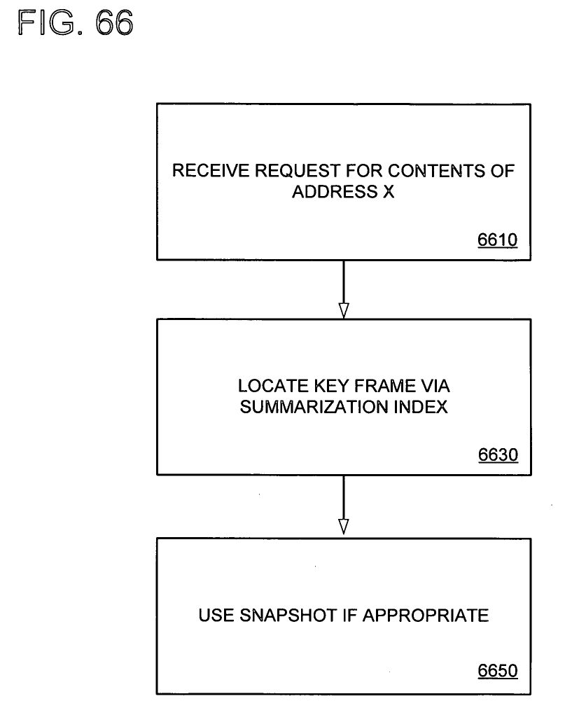

FIG. 66 is a flowchart showing an exemplary method 6600 of processing a request for the value of a memory address using snapshots. At 6610, a request for the value of address x is received (e.g., for a particular time within execution of a program). At 6630, key frame(s) are located via a summarization index. A snapshot of memory locations is used at 6650 if appropriate.

### Example 74

### Exemplary Method of Processing a Request for Memory Address Value

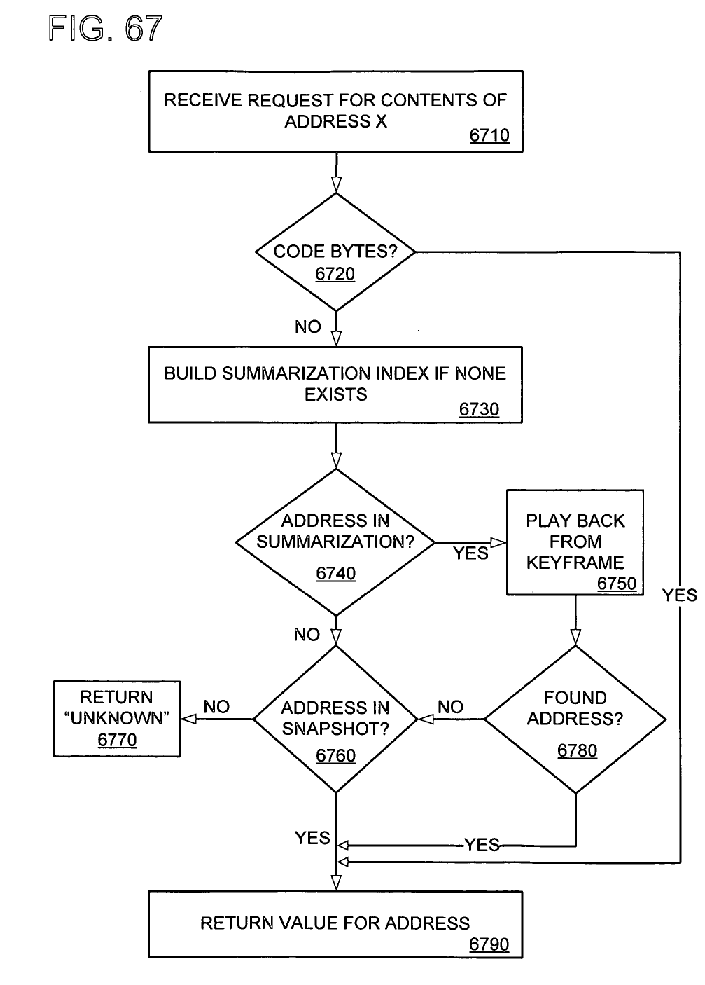

FIG. 67 is a flowchart of a method 6700 of processing a request for the value of a memory address using one or more snapshots and a summarization index; the method 6700 can be used in conjunction with any of the examples described herein.

At 6710, a request for the contents of address x is received. At 6720, it is determined wither the address is in the code space. If it is, the value for the code bytes are returned at 6790.

At 6730, it is determined whether there is a summarization index for the current position (e.g., of execution within the program recording). If not, one is built that goes back from the current position to a point in execution (e.g., a sequence) where a snapshot exists. In some cases, it may be desirable to go back more than one snapshot (e.g., in anticipation of additional requests for other addresses). For example, the summarization index can go back two, three, or more snapshots.

At 6740, it is determined whether the address is accessed in the summarization index. If it is, at 6750, playback begins from the keyframe and finds the instruction that accesses the address to determine the value. At 6780, if the address was found, the value is returned at 6790.

If the address was not found, at 6760, it is determined whether the address's value is in the snapshot that the summarization index borders. If so, the value is returned at 6790. Otherwise, the address is not referenced in the compressed program recording, and an “address unknown” result can be returned. In practice, such a result can be indicated to a user as a series of question marks (e.g., “???”).

The number of summarizations can be tuned for performance. In practice, snapshots tend to be larger than summarizations, so having too many snapshots can degrade performance. But, having fewer snapshots typically involves more simulation (e.g., via a virtual processor), and simulation is more efficient when a summarization can be consulted to determine where to simulate.

### Example 75

### Exemplary Compressed Program Recording Supporting Multiple Processors

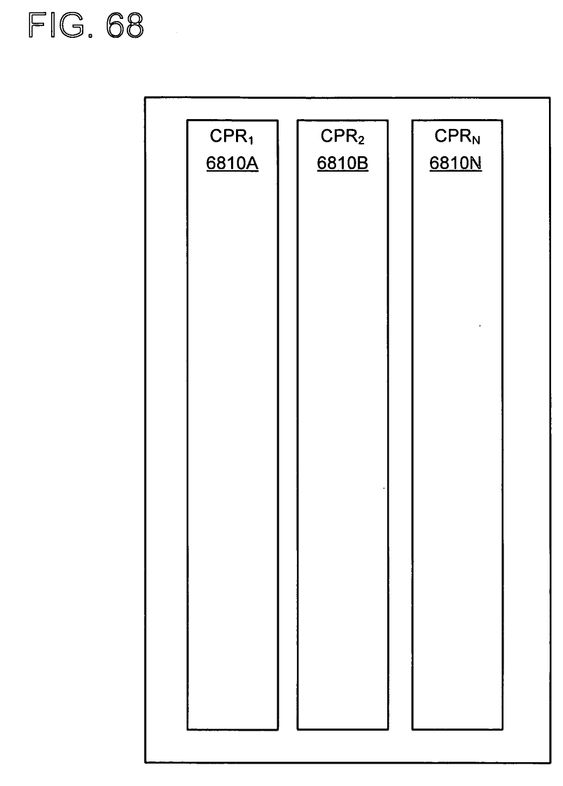

FIG. 68 shows an exemplary compressed program recording 6800 supporting multiple processors. In the example, a recording 6800 comprises two or more compressed program sub-recordings 6810A-6810N for respective processors.

For example, each of the sub-recordings can be a stream or some other arrangement of data indicating a compressed program recording generated via monitoring state changes for a respective processor.

Thus, execution of a program that runs on multiple processors can be recorded. A similar arrangement can be used for multiple threads, or multiple processors executing multiple threads can supported.

### Example 76

### Exemplary Method for Generating Compressed Program Recording Supporting Multiple Processors

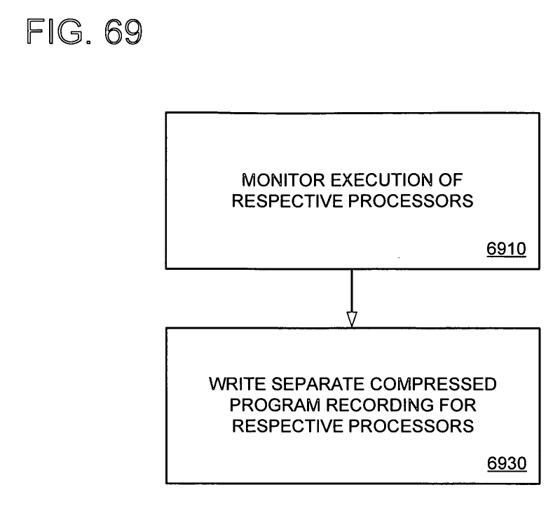

FIG. 69 shows an exemplary method 6900 of generating a compressed program recording supporting multiple processors. At 6910, execution of respective processors (e.g., state changes for the processors) are monitored.

At 6930, a separate compressed program recording is written for respective processors. Again, a similar arrangement can be used for multiple threads, or multiple processors executing multiple threads can be supported.

### Example 77

### Exemplary Compressed Program Recording Supporting Multiple Processors with Sequence Indications

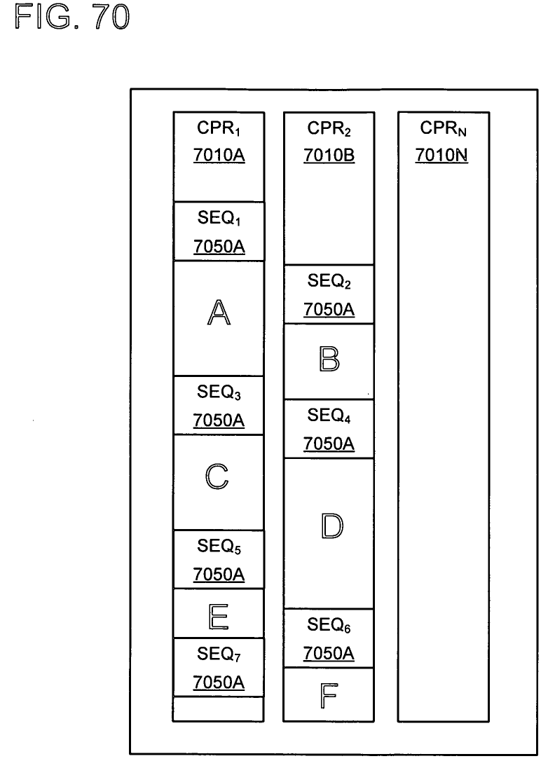

FIG. 70 shows an exemplary compressed program recording 7000 with compressed program sub-recordings 7010A-7010N for two or more separate processors. Included in the recording 7000 are sequence numbers 7050A-7050G. The sequence numbers can be used to help determine the order of the various segments of the sub-recordings 7010A-7010N. For example, it can be determined that the segment A for the recording 7010A for one processor is executed before the segment D for the recording 7010B for another processor.

In some cases, the sequences may not be dispositive. For example, it may not be conclusively determined that segment B for the recording 7010B executes after segment A for the recording 7010A. In such a case, when a request for the value of a memory address is received, multiple values may be returned. Such multiple values can be communicated to the developer (e.g., in a debugger) and may be indicative of a program flaw (e.g., a likely race condition).

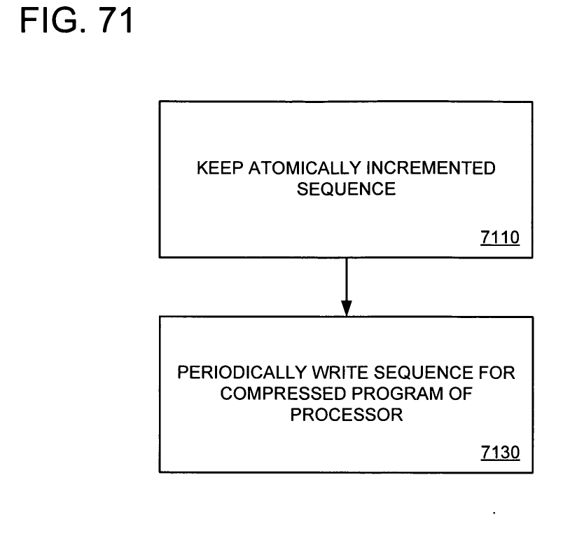

FIG. 71 shows an exemplary method 7100 for generating sequence numbers for a compressed program recording supporting multiple processors. In the example, an atomically-incremented sequence number (e.g., protected by a lock) can be used.

At 7110, the atomically incremented sequence number is maintained and incremented atomically when needed (e.g., an increment-before-write or increment-after-write scheme can be used). At 7130, the sequence is periodically written to the compressed program subsequence.

The sequence writes can be triggered by a variety of factors. For example, whenever a lock or synchronization instruction (e.g., inter-thread atomic communication instructions such as compare-and-exchange and the like) is encountered, the sequence can be written. Also, whenever the program goes into or out of kernel mode, the sequence can be written. For further analysis, the instructions between a pair lock instructions can be associated with the first instruction of the pair.

### Example 78

### Execution by Simulator

In any of the examples herein, monitored execution can be accomplished by using a software simulation engine that accepts the program under test as input. In this way, specialized hardware can be avoided when monitoring execution. Similarly, playback can consult a software simulation engine as part of the playback mechanism (e.g., as a predictor).

### Example 79

### Function Calls

Any of the technologies herein can be provided as part of an application programming interface (API) by which client programs can access the functionality. For example, a playback tool can expose an interface that allows a program to query values for memory locations, single step execution, and the like.

Further, a client can indicate via function call that it is particularly interested in a range of instructions. In response, key frames can be created during replay for the instructions within the range. Such an approach allows fast random access to positions close to the area of interest in the trace while still allowing for efficient storage of information outside the client's area of interest.

### Example 80

### Circular Buffer

In practice, during program recording, the compressed program recording can be buffered in memory before writing to disk. A circular buffer technique can be used whereby writing to disk is not necessary.

For example, as long as the buffer is large enough to hold a key frame and the information between the key frame and the next key frame, then some of the program's state can be recreated. In practice, with a large circular buffer, typically many key frames are used to support random access.

When using the circular buffer, a threshold size can be specified. When the amount of information for a compressed program recording exceeds the threshold, information from the beginning of the recording is overwritten with later information.

Such an approach can be useful because it is often the end of a recording that is of interest (e.g., shortly before a crash).

The threshold size can be any size accommodated by the system (e.g., 50 megabytes, 100 megabytes, 150 megabytes, and the like).

### Example 81

### Exemplary Additional Compression

In any of the examples described herein, the information in a compressed program recording can be further reduced in size by applying any compression algorithm. For example, streams of information about read operations can be compressed, indexes can be compressed, summarization tables can be compressed, or some combination thereof. Any number of compression techniques (e.g., a compression technique available as part of the file system) can be used.

### Example 82

### Different Machine Type

The compressed program recording can be saved in a format that can be transferred to another machine type. For example, execution monitoring can be done on one machine type, and playback can be performed on another machine. Portable compressed program recordings are useful in that, for example, execution can be monitored on a machine under field conditions, and playback can take place at another location by a developer on a different machine type.

To facilitate portability, the executable instructions (e.g., code bytes) of the program under test can be included in the program recording. For example, code (e.g., binaries) from linkable libraries (e.g., dynamic link libraries) can be included. Information useful for debugging (e.g., symbol tables) can also be included if desired.

If desired, the compressed program recording can be sent (e.g., piped) to another machine during recording, allowing near real-time analysis as the information is gathered.

Additional information can be stored to facilitate portability, such as machine configuration information, architecture, endianness (e.g., byte order) of the machine, and the like.

### Example 83

### Exemplary User Interface

A user interface can be presented to a developer by which the machine state as determined via the compressed program recording is indicated. Controls (e.g., single stepping, stepping backwards, jumping ahead n instructions, breakpointing, and the like) can be presented by which the developer can control the display of the machine state.

To the developer, it appears that the program is being executed in debug mode, but a compressed program recording can be used to avoid the full processing and storage associated with full debug mode.

### Example 84

### Exemplary File Format

Any number of formats can be used to store a compressed program recording. For example, the information can be saved in a file (e.g., on disk). In order to reduce contention between different threads of the program being monitored, data can be recorded for each thread independently in different streams within the file. For each stream, the data for simulating program execution during playback can be recorded.

The file format can include sequencing packets, read packets, executable instructions, and the like. For example, the sequencing packets can store the sequence information described herein. A global integer or timer can be used for the sequence. Sequencing events can be made uniquely identifiable so that ordering can be achieved.

On a single processor system, perfect ordering can be achieved by tracking context-swaps between threads. The sequencing events can also be used to track key frames (e.g., when a thread transfers control from kernel mode and user mode).

Read packets can record read operations from memory. Unpredictable reads can be stored.

The executable instructions can include the bytes of the instructions executed in the program. During replay, a simulator can fetch such instructions for simulated execution.

### Example 85

### Exemplary Memory

In any of the examples herein, the memory can be virtual memory. For example, memory accesses by a monitored program can be to virtual memory. Playback of a compressed program recording can then be used to determine the value of an address in such virtual memory (e.g., when a request for a value of an address in virtual memory is received).

### Alternatives

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the following claims. We therefore claim as our invention all that comes within the scope and spirit of these claims.

We claim:

1. A computer-implemented method of analyzing an execution of a program, the method comprising:
monitoring an executed instruction stream of the program; and
modeling one or more software constructs via one or more respective electronic representations of the one or more software constructs, wherein the modeling comprises updating the one or more respective electronic representations of the one or more software constructs based on executable instructions encountered in the executed instruction stream; and
detecting a program condition has occurred during the execution of the program via the one or more respective electronic representations of the one or more software constructs.

2. The computer-implemented method of claim 1 wherein the monitoring comprises monitoring the executed instruction stream of the program while the program is executing.

3. The computer-implemented method of claim 1 wherein:
the executed instruction stream comprises a recorded execution instruction stream recorded while the program executed on a virtual machine simulating execution on a native machine; and
the monitoring comprises monitoring the recorded executed instruction stream of the program.

4. The computer-implemented method of claim 1 wherein the program condition comprises a memory leak.

5. The computer-implemented method of claim 4 wherein the memory leak is detected via determining that no pointers to an object remain outside a heap.

6. The computer-implemented method of claim 1 wherein the program condition comprises use of a dangling pointer.

7. The computer-implemented method of claim 1 wherein the program condition comprises use of an uninitialized value.

8. The computer-implemented method of claim 6 wherein at least one high order byte is tracked separately from a low order byte for determining whether an uninitialized value has been used.

9. The computer-implemented method of claim 1 wherein at least one of the software constructs models pointers to objects of the program, the method further comprising:
with the at least one of the software constructs, tracking dataflow of pointers to objects.

10. The computer-implemented method of claim 9 wherein the tracking employs an algebra.

11. The computer-implemented method of claim 10 wherein the algebra recognizes exclusive or (XOR) operations.

12. The computer-implemented method of claim 1 wherein the program condition comprises a defect in the program, the method further comprising:
indicating the defect.

13. The computer-implemented method of claim 1 wherein the program condition comprises a defect in the program, the method further comprising:
labeling the defect with a distinguisher string based on a function that initiated an operation related to the defect.

14. One or more computer-readable media having computer-executable instructions for performing a method comprising:
detecting a defect in a monitored execution of a program, wherein the defect relates to a pointer to an object used by the program; and
responsive to detecting the defect, presenting a history of a plurality of copies of the pointer to the object in a user interface.

15. The one or more computer-readable media of claim 14 wherein the defect comprises a memory leak for the object used by the program.

16. The one or more computer-readable media of claim 14 wherein the method further comprises:
receiving an indication from a user of a location within the user interface, wherein the location corresponds to a time during execution of the program; and
responsive to receiving the indication from the user of the location within the graphical depiction, navigating to the time during execution of the program corresponding to the location in a debugger.

17. A computer-implemented method of detecting one or more defects in a software program, the method comprising:
in a first playback pass through a recorded execution of the program, analyzing the recorded execution of the program, wherein the analyzing comprises identifying one or more defects in the software program and one or more objects related to the defects; and
in a second playback pass through the recorded execution of the program, analyzing the recorded execution of the program, wherein the analyzing comprises storing one or more call stacks for the one or more identified objects.

18. The computer-implemented method of claim 17 wherein the one or more call stacks comprise a call stack when at least one of the one or more identified objects was created.

19. The computer-implemented method of claim 17 wherein the one or more call stacks comprise a call stack when at least one of the one or more identified objects was memory leaked.

20. The computer-implemented method of claim 17 wherein storing one or more call stacks comprises:
storing a call stack via a hash table.
